(19) United States
(12) Patent Application Publication
(10) Pub. No.: US 2018/0144378 A1
(43) Pub. Date: May 24, 2018

(54) METHOD, SYSTEM, AND APPARATUS FOR MANAGING FOCUS GROUPS

(71) Applicants: Alejandro Evaristo Perez, Dallas, TX (US); Federico Fraccaroli, Irving, TX (US)

(72) Inventors: Alejandro Evaristo Perez, Dallas, TX (US); Federico Fraccaroli, Irving, TX (US)

(21) Appl. No.: 15/859,300

(22) Filed: Dec. 29, 2017

Related U.S. Application Data
(63) Continuation-in-part of application No. 14/599,533, filed on Jan. 18, 2015, now abandoned.

(51) Int. Cl. G06Q 30/06; G06Q 30/02; G06F 17/30; G06Q 20/36

(52) U.S. Cl. CPC G06Q 30/06; G06Q 30/0201; G06Q 50/01; G06Q 20/36; G06F 17/30893; G06F 17/30867

(57) ABSTRACT

In accordance with one embodiment of the present invention, a method comprises aggregating multidimensional and multi-source data requests between data requesters and data suppliers into a single deal structure to broker a purchase, the rental, or the leasing of data via a trusted third party. In some implementations, data attributes, data objects, and data rights are validated, extracted, tested, treated, distributed, and securely stored in one or more remote server environments; data lakes; or a decentralized P2P network storage with block chain technology. A data deal structure can be enabled by comparing measured data attributes with attributes of record according to a predetermined rule algorithm/s, preset filter/s, data credibility measurement/s, work flow functionality, trigger mechanisms, and/or an associated meta tag/s. In some implementations, the present invention is used to organize large focus groups in virtual environments. In some implementations, e-wearables technology can be used to sync and validate the data supplier's data production to the user's devices and support the usage of a device by a plurality of users. In other implementations, a first set of data generates a hierarchy among users that is used to facilitate the collection of a second set of data.

### TECHNICAL FIELD

The present application generally relates to facilitating the creation process of focus groups and efficiently managing focus groups by aggregating a plurality of multi-dimensional and multi-source data requests from a plurality of users into a single data deal structure related to data objects and/or data rights generated inside of accounts and/or applications, such as a Netflix Accounts, Pandora Accounts, and/or Google Maps Applications, where the data attributes have been predetermined, evaluated, negotiated, brokered, validated (ex. via e-wearables), extracted, tested, treated, distributed, and securely stored in one or more remote server environments; or a modern P2P network storage. Surveys and questionnaires can be digitalized, and distributed according to a data deal structure. Certain aspects of the invention present a novel solution to manage, facilitate, transact, and enable businesses and large focus groups to interact with each other. Other aspects contemplate the usage of e-wearables, positioning techniques such as e.g. triangulation and proximity account switching. Other aspects contemplate using different tiers of users and different set of data to create those tiers of users.

### BACKGROUND

The teachings of Patent Application US 20030154171, Patent Application US 20090099852, Patent Application U.S. Pat. No. 8,694,423, Patent Application US 20160063077, Patent Application U.S. Pat. No. 8,429,040, Patent Application US 20130275177, Patent Application US 20080065409, Patent Application US 20120303754, Patent Application U.S. Pat. No. 7,113,998, Patent Application U.S. Pat. No. 6,973,500, Patent Application US 20170177682 are incorporated herein by reference in their entirety. Also, the teachings of the papers “A Bayesian View of Credibility” (Allen L. Mayerson, CAS Institute). The present application incorporates in its entirety all the disclosures of U.S. Patent Application US 20130015236 filed on Jul. 15, 2011 and titled “High-value document authentication system and method.”

The present application incorporates in its entirety all the disclosures of U.S. Patent Application US20140229735 filed on Aug. 8, 2012 and titled “Managing device ownership and commissioning in public-key encrypted wireless networks.”

The present application incorporates in its entirety all the disclosures of U.S. Patent Application US20130085941 filed on Sep. 30, 2011 and titled “Systems and methods for secure wireless financial transactions.”

The present application incorporates in its entirety all the disclosures of U.S. Patent Application US20110258443 filed on Jul. 23, 2010 and titled “User authentication in a tag-based service.”

The present application incorporates in its entirety all the disclosures of U.S. Patent Application US20150199547 filed on Jan. 11, 2014 and titled “Method, system and apparatus for adapting the functionalities of a connected object associated with a user ID.”

The present application incorporates in its entirety all the disclosures of Field Manual FM 6-2 of the Tactics, Techniques, and Procedures for FIELD ARTILLERY SURVEY published by HEADQUARTERS DEPARTMENT OF THE ARMY, Washington, D.C., 23 Sep. 1993.

A geofence is a virtual perimeter for a real-world geographic area. A geofence can be generated as in a radius around a point location such as a bar or a restaurant. A geofence can be a predefined set of boundaries connecting points expressed by latitude and longitude. Geofencing has been made possible especially by the introduction of GPS (Global Positioning System) technology and the miniaturization of electronic components that have made the locationing functionality a standard feature in Mobile Phones and portable electronics in general (User Equipment). Geofencing can be implemented via many other localization techniques, both indoor and outdoor.

In this application the term ‘geofencing’ or “geofence” is not limited to virtual fences provided by storing one or more geographical locations and parameters that can be retrieved and then compared to actual locations obtained by using GPS positioning but shall include all the possible techniques that may serve the purpose of defining a geographical area by using digital or electronic means such as for example the radio horizon that defines the range of a radio carrier such as, e.g., 3G, 4G, WLAN, Bluetooth and RF-ID around a fixed or mobile point. This technology produces geolocation data in which a possible implementation of the invention is installed in (ex. device), which can be extracted and shared with other applications.

As technology advances, different methods have been described to interact with proximate objects using RF-ID technologies. Some disclosures pertain to location-based functionalities such as, e.g., U.S. Pat. No. 8,150,439 titled “Facilitating user interactions based on proximity”. Some other disclosure pertain to methods for controlling a target device using another device such as, e.g., in U.S. Pat. No. 8,504,008 titled “Virtual control panels using short-range communication.” Some other disclosures illustrate an identification and verification system that makes it possible for a user to easily open locks and/or gain entry to secured systems such as, e.g., in U.S. Pat. No. 8,430,310, titled “Wireless directional identification and verification using wearable electronic devices.”

Geofencing technology can trigger or inhibit functionalities of location aware apparatuses. For example, as described in U.S. Pat. No. 7,813,741 titled “System and Method for Initiating Responses to Location-Based Events” a system may provide a response to one or more location-based services applications to provide location-based services, such as email, instant messaging, paging and the like. These interactions produced data, which are recorded within the user's account for their respective account (ex. mobile app level vs. desktop app level; Netflix vs. Amazon; device local user vs. network domain user). Location can be provided by many different techniques, for example triangulation with different Access Points or cellular Base Stations or signal strength data from various Access Point/Base Stations coupled with databases storing the location of various reference points. Geofencing technology can with other technologies, such as e-wearables (ex. AppleWatch, Fitbit).

A social network is a social structure made up of a set of actors (such as individuals or organizations) and the ties between these actors. One of means by which these actors can communicate nowadays is the Internet and there are many websites providing a common platform where these actors can interact. A social network provides a way of analyzing the structure of social entities. These interactions produce data for analysis to identify local and global patterns, locate influential entities, and examine dynamics. The actors become users when their account is created and that is when the actors' data production begins for that account. In the simplest terms, using this social media structures, the company Facebook already sells information about its users and promotes targeted marketing within its applications, interactions, and networks.

LinkedIn and Facebook are just some of the many different social network and applications where users have accounts. Many other networks and applications exist, targeting different facets of human desire for interaction. To date, some of the most popular are: Facebook, Snapchat, WhatsApp, Google+, Netflix, Flickr, Chrome, Skype, Meetup, and Amazon.com.

Big Data Technologies are technologies that refine and often organize large (Petabytes and above) unstructured and/or structured data, which are, under normal circumstances, stored in server farms referred as Data Lake/s. Traditionally, big data software systems (like Hadoop, Cassandra, MongoDB, SAP Hana, etc. . . . ) transform large data in non-real-time batches and, with modifications and other apps (such as a Spark module, Guavas Reflex Platform), can handle and/or refine and/or process large amount of data in real time. These technologies require Virtualization tools (VMware, Oracle Virtual Box) and administration tools (Windows Server 20xx, Ubuntu Server) to create cluster server architectures to reduce failovers and unique them into Server Farms to produce Data Lakes, which Big Data Technologies interact with. In an optimal operation state, these technologies can currently handle and process 20 Petabytes of data per day. AT&T's NTC (Network Technology Centers), which include several service systems. One of them is the Switching Serving Customer Traffic with ATM Switches, Data Routers, Load Balancers, and ISDN Switches. Another system is the Security Nexus Access with distribution components like Firewalls, CONEXUS load balancers, severlets, and Landing Zones. Other systems include data feeds which consolidate structured or unstructured data from the source/s to the main location in a specific format/s (cvs, .json, .txt). These data feeds can be assembled into large pools of information such as all the user's contacts, phone numbers called history, text messages sent, date of the events, system logs, and more. Data feeds can be internal to the organization, external to the organization, and a combination if multiple data feeds have the same software landing zones. These are currently the 5+ Petabytes data pools that the Big Data Technologies feed from. But there are other methods of creating large data pools besides owning NTCs (like AT&T, Verizon, and Sprint) or having hundreds of data feeds. New methods to create data pools can include data storage decentralization systems where device users store the data in their smart phones. Or data block chain systems which try to follow the bitcoin model. NTC has a membership limitation problem and “mutually exclusive” game, since not all mobile phone users are subscribed to AT&T and most users will not be an AT&T subscriber and a Sprint subscriber at the same time. Data feeds have the limitation of data integrity and format issues. Data feeds tend to be modified by the owners and no standardized data schemas are set. Thus, data feeds can conflict and create duplicate data in the data lakes or, worst, contaminate several data lakes with simple user error. The fact that data feeds are no standardized, asynchronous, different formats, nor source connection is questionable, there is a constant data integrity issue.

As for Data Analytics Applications, there are over 30 variations of software like Tableau, Microsoft Power BI, IBM Cognos, Palantir's Gotham, and more. These software import data in a specific format/s to produce visualizations of the data into understandable images and business insights. This is normal for marketing research and government research which requires facts, data, graphs, charts, maps, and simplified statistics (ex. ratios, percentages) for decision making. These types of software have drill down/up abilities and unique features like heat maps to answer questions like “where do most people move around a mall?” or “How do people move their mouse on the website screen?” like the CrazyEgg Heatmap Software. Big Data Tools can refine and provide the required format for the Data Analytics Tools for optimal value by visualizing large statistical samples without collapsing the Data Analytics Tools in the process.

Current data systems that broker money for data are for one-dimensional transactions as a one to one ratio. However, data trading transactions tend to be complex, multi-dimensional, and multisource. A typical example of this problem is when a company needs a unique combination of data sets about its customers, such as social media apps for demographics, map apps for geolocation, shopping accounts for buying habits, and shopping apps for point of sale information. The complexity increases when those customers do not use the same data-producing sources or a combination of data-producing sources, such different browsers (ex. Chrome vs Safari; Chrome and Firefox), diverse social media apps (ex. Facebook vs Snapchat; Snapchat & Instagram), shopping mediums (Amazon vs Alibaba; eBay and Amazon), dissimilar search engines (Bing vs Google Search; Bing and Google), diverse financial apps (PayPal vs Apple's Wallet; PayPal and Visa NOW app), different health apps (Fitbit vs. Health; Fitbit & Nike+) and so for. Using Prior Art to broker these complex data requests between data requester/s and data suppliers produces an exponential amount of transitions that would overwhelming any human participant due to their one-to-one ratio dimensionality.

In addition, the speed of the Information Age creates quick abandonment of accounts and apps; and the ability to create false accounts, which can be controlled by scripts to imitate customer activity. In addition, in 2016, according to Tech Crunch, 23% of mobile app users abandon a new app after its first use.

The present invention combines, adapts, and adds to some of the above-mentioned concepts, technologies and observations by way of a synergetic and novel approach a method, a system and an apparatus to, e.g., improve multidimensional multisource data transactions, focus groups creation, and/or items, and/or furthering business transactions and/or enabling secure functionalities associated to mass data brokering and/or items.

### SUMMARY

Various aspects of examples of the invention are set out in the claims.

A method of the present invention for brokering large focus groups. With this technology, data requestors can quickly mobilize data suppliers into large focus groups and validate device users with the proximity account switching feature. This novel brokering system solves the problems created by multidimensional and multi-source data requests by aggregating the requests into a customized single deal structure, a data deal, which drastically reduces data transactions, reconsolidates source mismatches, synergizes focus group scalability, and improves the quality and speed of the data gathering process between data requesters and data suppliers. A data deal can extract real-time data and/or historical data from data suppliers to predetermine and manage which data suppliers are the best statistical population sample size for the data requestors based on filters and criteria enforced by several mechanisms. In a data deal, data requesters and data suppliers may negotiate with the parameters set by system. Depending of the type of data deals (buy/sell, rent, and/or leasing) and upon a triggering, data requestors can gain access to big data lakes and/or directly receive the data suppliers' brokered data groupings (data sets, data blocks, data compositions, and/or other data sources) after data treatments like anonymization. Data requestor/s can easily place the data into business analytics units. With these abilities and tools, data requestor/s can mobilize, monitor, and interact with their data suppliers within their respective data deal in real time to produce business insights and modify business actions in order to increase revenues, find cost savings, build new markets, promote product substitution, improve product deployments, develop new services, and/or other value-added activities.

A second aspect of the present invention is to organization, sustain, provide payments, validation (ex. via e-wearables), anti-hacking securities, and privacy assurance to manage and administer large focus groups. Especially if data request/s renews and expands a data deal in order to expand a large focus group population size from a statistical population sample size to actual population size monitoring.

According to a third aspect of the present invention, a computer software system has a set of instructions for controlling at least one general-purpose digital smart device in performing desired functions comprising a set of instructions formed into each of a plurality of modules, each modules comprising of 1) a smart device (ex. iPhone) as a user equipment; 2) a process for receiving a location data associated from said user equipment (ex. Google Maps, GPS location consented); 3) a process for comparing said location data with a location of record for another set user equipment (ex. e-wearable), a simple biometric; or other known methods. 4) a process for securely coping and transferring data to a set location for data brokering and data treatments; 5.) a process and method of matching, processing, and recording data transactions.

A fourth aspect of the present invention enables the utilization of the data level structure introduced (data point, data set, data block, data deal, data composition), which allows for the same data deal mechanics to reused in secondary data markets to third party data brokers resell, re-rent, and/or sublease data lakes and/or environments associated with multiple data deals, data compositions, and other external data.

A fifth aspect of the present application focuses on a hierarchical and systematic method of data collection from customers so that the computer hardware needed to execute the functionalities described herein accomplishes tasks more efficiently and reliably. In this implementation, the data collected from users' accounts can be divided in at least two subsets. The first type set is used to rank users according to a series of parameters such as usefulness to a specific data deal and their credibility in relation to that data deal. The second type subset is the actual set of data that are extracted by the various data suppliers that are pertinent to said specific data deal. In certain implementations, there is a permission to be asked to the various data suppliers to access the second subset of data. Said permission can be asked hierarchically starting first with those data suppliers that fit the data deal parameters most closely or are more credible according to predetermined parameters. In other implementations, the access to said second set of data can occur automatically if data suppliers have provided an authorization in advance. The harvesting of second type data sets may occur hierarchically, starting with data suppliers that according to type one data set provide the most value. A hierarchical approach to data harvesting ,(starting with higher tier data suppliers and only in a second stage, if needed, collecting or asking permission to collect from lower tier data suppliers), will result in a better utilization of the computing and communication resources. Higher tiers of data suppliers means, e.g., that those data suppliers have a higher credibility score, provide data that are more related and richer in meaning for the specific data deal. In certain instances, a predetermined degree of confidence on certain data can be acquired rather easily if data suppliers belonging to higher tiers choose to opt in. In other instances, when higher tier users does not opt in, meaning he does not accept having his type two data mined, the computer system may dynamically extend the deals and/or the request for authorization and/or a financial compensation offer hierarchically to lower tiers. Statistical algorithms may dynamically compensate for a low reliability score concerning second type subset data by enlarging the sample population.

In certain implementations, users belonging to different tiers can be compensated according to different pricing structures. For example, users who choose to allow first type set of data to be rich in quality and quantity of data may be compensated at higher rates when they release second type set of data. The person skilled in the art will understand that a top down approach to data harvesting, meaning using different tiers of users and initiating requesting and collecting data from top tiers has beneficial effects toward the computer system since once a target threshold of quality and quantity of data has been reached no more communications and or signaling will be necessary with lower tier data suppliers.

Many algorithms can be implemented that can be adaptive. For example, quantity threshold, quality threshold, compensation per tier of Data suppliers threshold can adapt dynamically to satisfy different kind of data deal and acceptance rates by data suppliers per different tiers.

### BRIEF DESCRIPTION OF THE DRAWINGS

For more a complete understanding of example embodiments of the present invention, reference is now made to the following descriptions taken regarding the accompanying drawing in which:

FIG. 1A represents a simplified possible schematic embodiment of the invention describing the methods, system, and apparatus from zoomed out top level between the data requestors, data deal brokers, data suppliers, data deals, data lakes, and data sets to create large focus groups.

FIG. 1B represents a simplified possible schematic embodiment of the invention describing a system implementation of the logical structures of data within a generic smart phone or equivalent personal equipment.

FIG. 2 represents a simplified possible schematic embodiment of the invention describing a system implementation of the stacking of Data Deals within a generic smart phone or equivalent personal equipment.

FIG. 3 represents a simplified possible schematic embodiment of the invention describing a system implementation of a Data Composition.

FIG. 4 represents a simplified possible schematic embodiment of the invention describing a system implementation; implementation of the macro-level as Data Deal used in a Secondary Market by combining Data Deals, Data Compositions, and/or Eternal Data.

FIG. 5 represents a simplified and exemplary representation of workflow diagram; other possible workflow diagrams can be used for the invention describing a system implementation show the steps and interactions between the user and the data deal.

FIG. 6 represents a simplified and exemplary representation of workflow diagram and mechanisms; other possible workflow diagrams can be used for the invention describing a system implementation show the steps and interactions between the user and the data deal; and additionally showing the mechanisms triggered during those decisions and interactions.

FIG. 7 represents a simplified and exemplary representation of workflow diagram and mechanisms; other possible workflow diagrams can be used for the invention describing a system implementation show the steps and interactions between the user and the data deal; and additionally showing the rules that determine those decisions and interactions.

FIG. 8 represents a simplified and exemplary representation of legend for workflow diagrams; other possible workflow diagrams can be used describing a system implementation to explain all data deal flows decision points.

FIG. 9 represents a simplified and exemplary representation of workflow diagrams, mechanisms, and rules; other possible workflow diagrams can be used describing a system implementation on a smart device for a Data Deal interacting with those rules and mechanisms. One of the possible purposes is to guide the User of the novel technology, broker the Parties, and entice a User to join one or more focus groups.

FIG. 10 represents a simplified and exemplary representation of workflow diagrams, mechanisms, and rules; other workflow diagrams can be used to describe the invention of a system implementation on the smart phone for a Data Deal interacting with those rules and mechanisms. One of the possible purposes is to guide the User, broker the Parties, and entice a User into joining one or more focus groups.

FIG. 11 represents a simplified and exemplary representation of workflow diagrams, mechanisms, and rules; other possible workflow diagrams can be used to describe a system implementation on a smart phone for a Data Deal. A data Supplier and a Data Requesters can interact according to a set of rules and mechanisms. One of the possible purposes is to guide the User, broker the Parties, and entice a User into joining one or more focus groups.

FIG. 12 represents a simplified and exemplary representation of workflow diagrams, mechanisms, and rules; other possible workflow diagrams can be used for the invention describing a system implementation on a smart device for a Data Deal. A data Supplier and a Data Requesters can interact according to a set of rules and mechanisms. One of the possible purposes is to guide the User, broker the Parties, and entice a User into joining one or more focus groups.

FIG. 13 represents a simplified and exemplary representation of workflow diagrams, mechanisms, and rules; other possible workflow diagrams can be used for the invention describing a system implementation on a smart device for a Data Deal. A data Supplier and a Data Requesters can interact according to a set of rules and mechanisms. One of the possible purposes is to guide the User, broker the Parties, and entice a User into joining one or more focus groups.

FIG. 14 represents a simplified and exemplary representation of workflow diagrams, mechanisms, and rules; other possible workflow diagrams can be used for the invention describing a system implementation on a smart device for a Data Deal. A data Supplier and a Data Requesters can interact according to a set of rules and mechanisms. One of the possible purposes is to guide the User, broker the Parties, and entice a User into joining one or more focus groups.

FIG. 15 represents a simplified and exemplary representation of workflow diagrams, mechanisms, and rules; other possible workflow diagrams can be used for the invention describing a system implementation on a smart device for a Data Deal. A data Supplier and a Data Requesters can interact according to a set of rules and mechanisms. One of the possible purposes is to guide the User, broker the Parties, and entice a User into joining one or more focus groups.

FIG. 16 represents a simplified and exemplary representation of workflow diagrams, mechanisms, and rules; other possible workflow diagrams can be used for the invention describing a system implementation on a smart device for a Data Deal. A data Supplier and a Data Requesters can interact according to a set of rules and mechanisms. One of the possible purposes is to guide the User, broker the Parties, and entice a User into joining one or more focus groups.

FIG. 17 represents a simplified and exemplary representation of workflow diagrams, mechanisms, and rules; other possible workflow diagrams can be used for the invention describing a system implementation on a smart device for a Data Deal. A data Supplier and a Data Requesters can interact according to a set of rules and mechanisms. One of the possible purposes is to guide the User, broker the Parties, and entice a User into joining one or more focus groups.

FIG. 18 represents a simplified and exemplary representation of workflow diagrams, mechanisms, and rules; other possible workflow diagrams can be used for the invention describing a system implementation on a smart device for a Data Deal. A data Supplier and a Data Requesters can interact according to a set of rules and mechanisms. One of the possible purposes is to guide the User, broker the Parties, and entice a User into joining one or more focus groups.

FIG. 19 represents a simplified and exemplary representation of workflow diagrams, mechanisms, and rules; other possible workflow diagrams can be used for the invention describing a system implementation on a smart device for a Data Deal. A data Supplier and a Data Requesters can interact according to a set of rules and mechanisms. One of the possible purposes is to guide the User, broker the Parties, and entice a User into joining one or more focus groups.

FIG. 20 represents a simplified and exemplary representation of workflow diagrams, mechanisms, and rules; other possible workflow diagrams can be used for the invention describing a system implementation on a smart device for a Data Deal. A data Supplier and a Data Requesters can interact according to a set of rules and mechanisms. One of the possible purposes is to guide the User, broker the Parties, and entice a User into joining one or more focus groups.

FIG. 21 represents a simplified and exemplary representation of workflow diagrams, mechanisms, and rules; other possible workflow diagrams can be used for the invention describing a system implementation on a smart device for a Data Deal. A data Supplier and a Data Requesters can interact according to a set of rules and mechanisms. One of the possible purposes is to guide the User, broker the Parties, and entice a User into joining one or more focus groups.

FIG. 22 represents a simplified and exemplary representation of workflow diagrams, mechanisms, and rules; other possible workflow diagrams can be used describing a system implementation on a smart device for a Data Deal. A data Supplier and a Data Requesters can interact according to a set of rules and mechanisms. One of the possible purposes is to guide the User, broker the Parties, and entice a User into joining one or more focus groups.

FIG. 23 represents a simplified and exemplary representation of workflow diagrams, mechanisms, and rules; other possible workflow diagrams can be used describing a system implementation on a smart device for multiple Data Deal. A data Supplier and a Data Requesters can interact according to a set of rules and mechanisms. One of the possible purposes is to guide the User, broker the Parties, and entice a User into joining one or more focus groups.

FIG. 24 represents a simplified possible schematic embodiment of the invention describing a system implementation on a smart phone for a Data Deal interacting with those rules and mechanisms. One of the possible purposes is to guide the User, broker the Parties, and entice the User into joining multiple focus groups.

FIG. 25 represents a possible mathematical representative embodiment of the invention. The exemplary arithmetic is represented for a 50,000 users implementation for a Data Deal.

FIG. 26 represents a possible mathematical representative embodiment of the invention. The exemplary arithmetic is represented for a 170,000 users implementation for multiple Data Deals. In this case, the figure illustrates the increased complexity of data permutation transactions brought by additional Data Deals.

FIG. 27 represents a simplified and exemplary representation of a legend for rules in the workflow diagrams; other possible workflow diagrams can be used for the invention describing a system implementation of rules determine whether a Data Deal is in a particular status and what Data Sets are in another status.

FIG. 28 represents a simplified and exemplary representation of a legend for rules in the workflow diagrams; other possible workflow diagrams can be used for the invention describing a system implementation of rules determine whether a Data Deal is in a particular status and what Data Sets are in another status.

FIG. 29 represents a simplified and exemplary representation of a legend for rules in the workflow diagrams; other possible workflow diagrams can be used for the invention describing a system implementation of rules determine whether a Data Deal is in a particular status and what Data Sets are in another status.

FIG. 30 represents a simplified and exemplary representation of a legend for rules in the workflow diagrams; other possible workflow diagrams can be used for the invention describing a system implementation of rules determine whether a Data Deal is in a particular status and what Data Sets are in another status.

FIG. 31 represents a possible mathematical representative embodiment of the invention. The exemplary arithmetic is represented for a 170,000 users implementation for multiple Data Deals. In this case, the figure illustrates the increased complexity of data permutation transactions brought by additional Data Deals. The figure illustrates the beneficial reduction of data permutation transactions brought by the Data Deal activation methods.

FIG. 32 represents a simplified possible schematic embodiment of the invention describing a representative implementation were the quality of the data increases when using e-wearable technology, locationing systems such as GPS, and the application of a proximity account switching via a technology such as Bluetooth technology where the primary device is transferred between users of e-wearables and the system logs the change in data suppliers.

FIG. 33 represents a simplified possible schematic embodiment of a system implementation were the quality of the data increases due to using e-wearable technology, locationing systems such as GPS, and the application of a proximity account switching via a technology such as Bluetooth technology where the primary device is transferred between users of e-wearables and the system logs the change in data suppliers. The system accounts for the inverse change in data suppliers.

FIG. 34 represents a simplified possible schematic embodiment of a system implementation were the quality of the data may increase due to using e-wearable technology, GPS triangulation, and the application of a proximity data tier grading based on the proximity of the data supplier to the data supplier's smart phone which is producing the data. Using, e.g., an iWatch with GPS capability, the data supplier can be constantly monitored with precision since two GPS positions (watch and smartphone) can be available and thus improving the quality of the data.

FIG. 35 represents a simplified and exemplary representation of a workflow interface, mechanisms, and rules; other possible workflow diagrams can be used describing a system implementation on a smart device where a Data Deal Broker uses an implementation of the Data Deal Portal to interact with the Data Requestors, Data Suppliers, Data Deals, rules and mechanisms.

FIG. 36 represents a simplified and exemplary representation of a system, to optimize computer resources and the functioning of a method to manage focus groups based on the creation of hierarchies among data providers associated with user equipment. In certain implementations, said hierarchies can be tested via an aggregation parameter.

### GLOSSARY

The person skilled in the art knows that terms such as Requestor/s and/or Data Supplier/s and/or Data Deal Brokers correspond to user accounts representing profiles of users, organizations, or companies that are stored on non-volatile memory in a computer machine or server. Informally, throughout the present patent application, these and other terms might sometimes be used as proxies for users, companies and/or organizations that are linked to datagram/s. Requestor/s and/or Data Supplier/s and/or Data Deal Brokers are collections of organized data, information and/or sometimes executable code that occupy tangible portions of non volatile memories storing information, privileges, parameters, profiles related to said users, companies or organizations enabling the execution of functionalities described in the present application.

Throughout the present patent application, terms such as Method/s, Set/s, Deal/s, Point/s, Block/s, Composition/s, Requestor/s, Supplier/s, Broker/s, Right/s, Portal, Quote, Scores, Requests, Requirement, Markets, Lakes, Data, Action, Flows, Mechanisms, Switching, Grading represent collection of data and/or rules and/or functionalities and/or profiles and/or outputs and/or inputs that are all made possible by the storing of data and or executable code on one or more non-volatile memories.

This does not exclude that sometimes outputs, data and even executables may be stored, at least temporarily on volatile memories.

101 Data Sets—In one embodiment of the invention, Data Sets are a grouping of Data Points 103 from a logical data set, data source, data account, and/or Data Rights 109 that Data Requestor/s 106 would find of business value. Data Supplier 107 represent user/s accounts stored on non-volatile memories. A Data Supplier 107 owns, has, and/or produces data in those accounts via User Equipment 129 (ex. iPhone) interactions. Data Sets normally represent the Data Supplier's 107 personal accounts, such as their Facebook Account, Amazon Account, Pandora Account, Experian Account, Netflix Account, Safari Account, and more. Data Set/s can provide demographic data, mobile application/s data and their activity, desktop application/s data and their activity, public information, medical information, credit information, browser history, browser data and their activity, records, music, social media, gaming sessions, online transactions, device used during the session, and more. In one implementation, Data Suppliers 107 can be proxies for users accounts. Due to the diversity of data producing accounts, these Data Set/s 101 are group into Data Blocks 104 to reduce exponential transactions via a single Data Deal 102. Data Set/s can be traded using Data Negotiation Parameters Methods 418 to determine their market value. As a transaction reduction method, a Data Set/s once activated can apply other Data Deals 102 that require that specific Data Set via a simple auto-fill technique. Thus, an activated Data Set can apply to a plurality of Data Deals 102. Additional nomenclature can include Data Set/s, Data Accounts, Data Stocks, Data Stock, Datastock, Data Source, Data Origin, and/or Data Sources.

102 Data Deal/s—In one embodiment of the invention, Data Deals organize large focus groups. Data Deal can be created via Data Deal Brokers. The person skilled in the art will know that “large” is a relative term and should be seen just as explanatory rather than limiting. Data Deal/s can be seen as a mechanism that aggregates and simplifies Multi-Dimensional Multi-Source Data Request 125 for a grouping of Data Sets 101 and/or future grouping of Data Sets 101 (Data Sets 101 yet to be processed by the system) that Data Requestors 106 are asking for from Data Suppliers 107. A Data Deal 102 can be sponsored by one or several Data Requestors 107. The criteria, filters, pricing parameters are set by the Data Requestor/s 107. Once set, the Data Deal Brokers 108 use the Data Deal Creation & Release Methods 411 to release the Data Deal 102 to the Data Suppliers 107. Data Suppliers can activate and deactivate Data Sets 101 and Data Deals 102 via the Data Activation Methods 410. The Data Deal 102 validates Data Supplier/s 107 via the Data Source Validation Methods 415, extracts their Data Points 103 via Data Extraction Methods 421, determines qualifications via the Data Deal Filters Mechanisms 414 and the Nullification Methods 416, brokers the Data Set/s 101 pricing based on Data Negotiation Parameters Methods 418.

Upon meeting the Data Deal Triggers Methods 419 and a Data Supplier 107 enters into a contract for a specific Data Deal 102, the Data Deal 102 module activates payment to the Data Suppliers 107 via Payment Schedule Methods 420, extracts and treats the data via the Data Extraction Methods and Data Treatment Methods 421, and then transfers the data to the Data Lakes 132 using Data Transfer Methods 422. Environment/s and data ownership is based on whether the Data Deal 102 is a rental, a purchase, or a lease. Even after contracting, continuous Data Source Validation Methods 415 and Nullification Methods 416 are used to ensure the quality of the Data Sets 101 and their respective Data Points 103 are extracted. In addition, Data Deal 102 module grants the Data Requestor 106 to interact with Data Suppliers 107 for additional compensation via surveys and interviews.

In secondary markets, Data Deals 102 can be used to transact a combination of Data Compositions 105, other Data Deals 102, external data 133, and/or other sources of data that Data Requestors 106 from Data Suppliers 107 for a compensation. Alternative nomenclatures for Data Deals 102 are Business Data Deal, Data Bundle, Data Bundle Deal, Data Categories Deal, Data Block Deal, Data Compositions Deals, Massive Focus Group Deal, Focus Group Deal, etc. . . . .

103 Data Point/s—In one embodiment of the invention, Data Points are a data source or key data inside a Data Set 101 that a Data Requester/s 107 would find business value. Data Points are normally produced by the Data Supplier/s 107 via a UE 129. A Data Set has multiple Data Points. Data Points are both generic and unique to every Data Set 101. Generic data points are Session Durations, Frequency of Use, Time of Session, Clicks, Device Type, Mode, Carrier Information, Demographics, Geo Location of Sessions, History, and more. Unique Data Points are Data Set 101 dependent, such as Facebook Likes, Amazon Purchases, iTunes Libraries, LinkedIn Occupation Type, Western Union country of transfer, and more. Data Points are divided between Authorized Data Points (ex. Duration of Sessions, Purchases, Clicks) and Banned Data Points (ex. social security number, pornographic information), based on privacy policies, and government mandates, which can be processed Data Treatment Methods 423 upon contracting of a Data Deal 102.

104 Data Block/s—In one embodiment of the invention, Data Blocks are a group of diverse Data Set/s 101 or elements displayed in a Data Deal 102. In this case, the Data Blocks groups the Data Sets 101 and can create the benefit of data redundancy and transaction action reduction. Ideally, each activated Data Set 101 that the Data Supplier 107 activated via the Data Activation Methods 410 produce more Data Points 103 that can be used for continuous-validation, managing Data Credibility Scores 117, and, above all, to monitor the Data Suppliers' 107 behavioral habits in the Data Deal 102. Within a Data Block, a Data Requestor/s can set a rule for a minimum amount of Data Set/s 101 (Data Block Minimum Requirement 130) to be activated by the Data Supplier 107 via Data Source Validation Methods 415. This can guarantee a certain quality of data. This minimum requirement can be set by the Data Requester 106, since not all Data Suppliers 107 have the same Data Set/s 101 and, at times, multiple Data Sets 101. Each activated Data Set 101 in the Data Block provides compensation to the Data Supplier 107 via the Data Negotiation Parameters Methods 418, but the system allows block pricing.

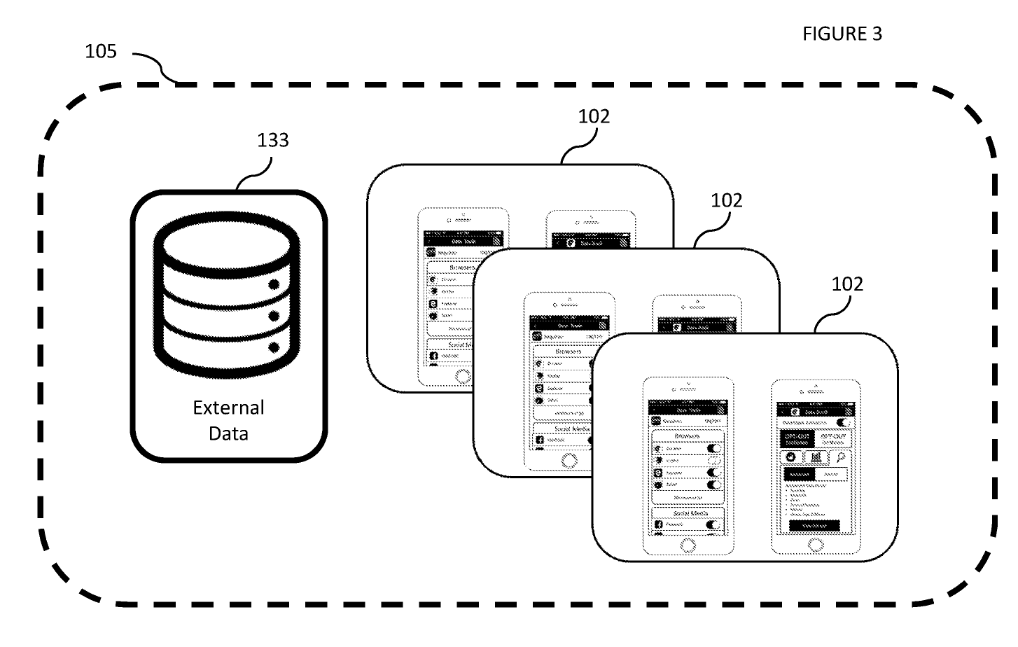

105 Data Compositions—In one embodiment of the invention, Data Composition/s are a group of data from Data Deal/s 102 and/or External Data 133. Data Composition are normally placed in Data Lakes 132 where the Data Requesters 107 combine the data from a Data Deal 102 and their own corporate data to produce richer insights, correlations, statistical analysis, and/or other research produced by constantly monitoring the data of multiple sets of focus groups in Data Deals 102 simultaneously. FIG. 3 illustrates an example of a Data Composition.

106 Data Requestor/s (or Requester/s)—In one embodiment of the invention, Data Requestors represent an entity or group of entities that require data for research and monitoring to create value. Entities can range from businesses, governments, non-profits, corporations, and other groups. Data Requestors can use the Data Deal Portal 112 to request Data Deals 102. Informally, throughout the present patent application, this terms might sometimes be used as proxies for users, companies and/or organizations.

107 Data Supplier/s—In one embodiment of the invention, Data Supplier/s can be a person, entity, or group of entities that owns, has, shares and/or produces data via a smart devices (User Equipment 129) linked to Data Sets 101 that Data Suppliers can active within Data Deals 102 for an incentive. With the help of the methods, system, and the assistance of Data Brokers 108, the Data Requestors 106 and Data Supplier quickly negotiate per Data Deal 102 and generate large statically sample focus groups. Depending on the terms and early software prototype testing, a Data Deal 102 can mobilize 50,000 Data Suppliers within 3 minutes to 10 minutes depending auto-fill mechanisms were configured in the apparatus to quickly activate Data Sets 101, such as LastPass Password Manager, Dash Lane Password Manager, and/or Apple Wallet Password Manager. Informally, throughout the present patent application, this terms might sometimes be used as proxies for users, companies and/or organizations.

108 Data Deal Brokers—In one embodiment of the invention, Data Deal Brokers 108 can negotiate, manage, facilitate and broker Data Deal/s 102 between Data Requester/s 106 and Data Supplier/s 107 via the Data Deal Portal 112 and commercial methods. Informally, throughout the present patent application, this term might sometimes be used as proxies for users, companies and/or organizations.

109 Data Rights—In one embodiment of the invention, Data Rights are the legal right to access, collect, treat, and/or block Data Points 103 within activated Data Sets 101 from the Data Suppliers 107 to the Data Deal Brokers 108. Data Rights can be granted per Data Set 101 via Data Activation Methods 410. Data Rights grant the right to block data usage to other entities via Data Blocking Methods 424.

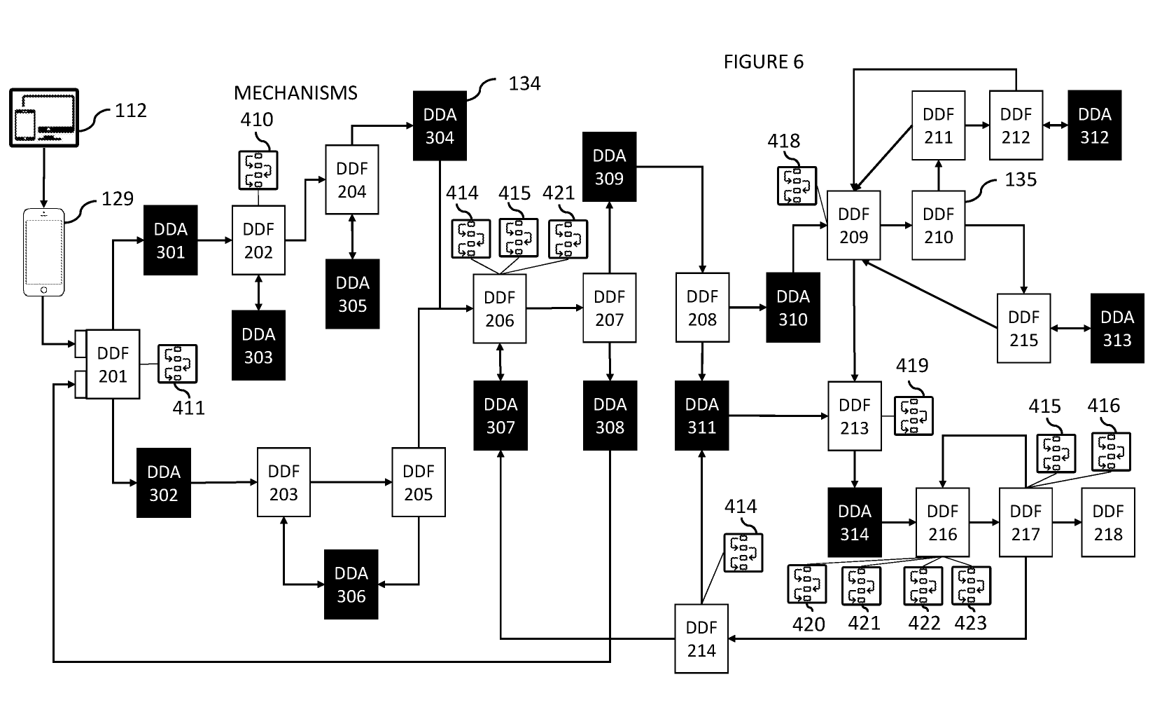

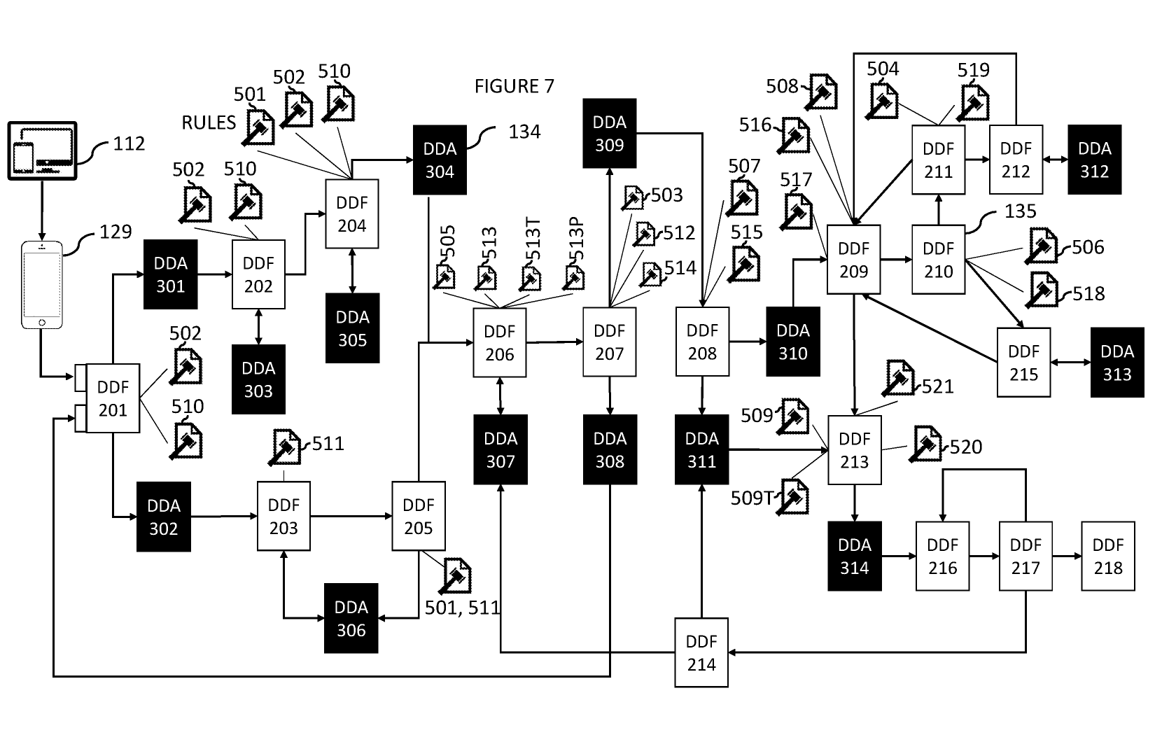

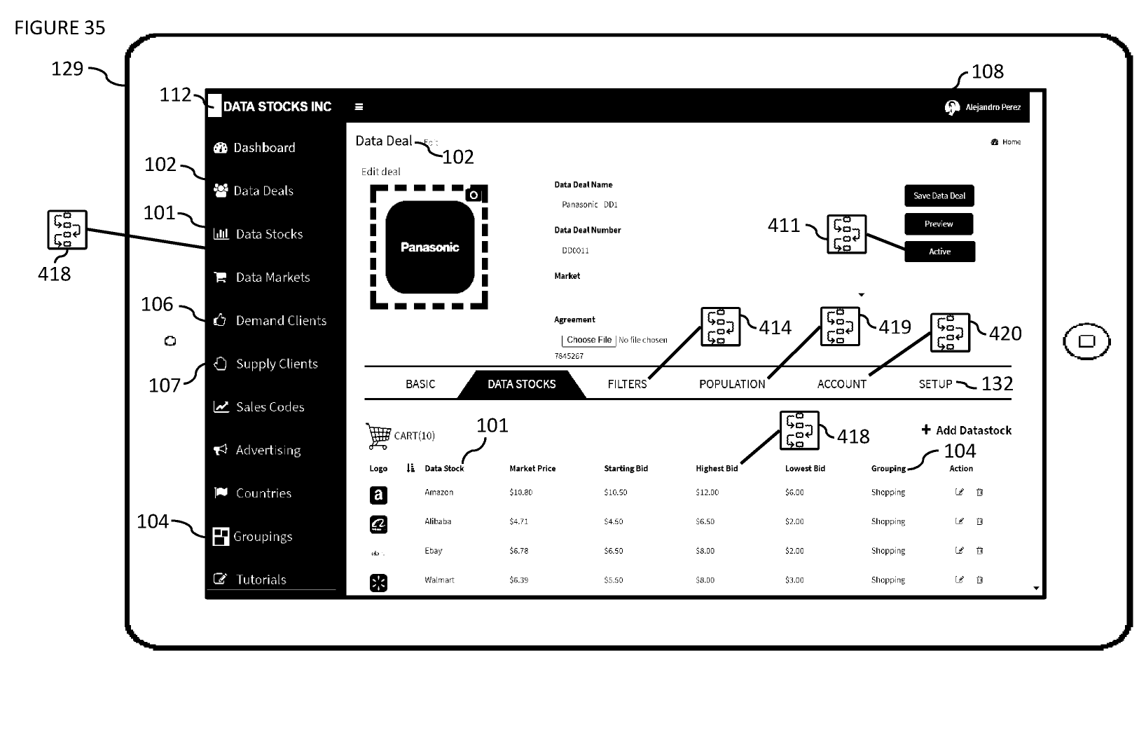

112 Data Deal Portal—In one embodiment of the invention, Data Deal Portals are administration management software module for Data Deal Brokers 108 for create, manage, modify, close, and/or delete Data Deals 102, Data Sets 101, Data Points 103, Data Blocks 104, Data Compositions 105, Mechanisms FIG. 6, Rules FIG. 7, the Data Lakes 132, environments, focus group management, records, and more. The Data Deal Portal can be appreciated in FIG. 35 and can be hosted on the Data Deal Brokers' 108 website, but it is not limited to this. In addition, in this Data Deal Portal, Data Requester/s 106 can prepopulate the mechanisms and rules of a Data Deal 102 by creating a Data Deal Quote 113, setup their pricing, select the filters, population size, and more. This module is currently located at https://www.datastocksinc.com/data-deals.php as a demonstration prototype.

113 Data Deal Quote—In one embodiment of the invention, Data Deal Quotes are electronic preliminary Data Deal 102 request from Data Requester/s 106 to the Data Deal Brokers 108. The Data Requester/s 106 can setup their pricing per Data Set 101, select the filters 414 per Data Deal 102 and/or Data Set 101, population size, and more. A Data Deal Quote can prepopulate a Data Deal 102 to reduce dual entry and facilitate automation. The Data Deal Request Portal 112 is currently located a live prototype can be found at https://www.datastocksinc.com/data-deals.php

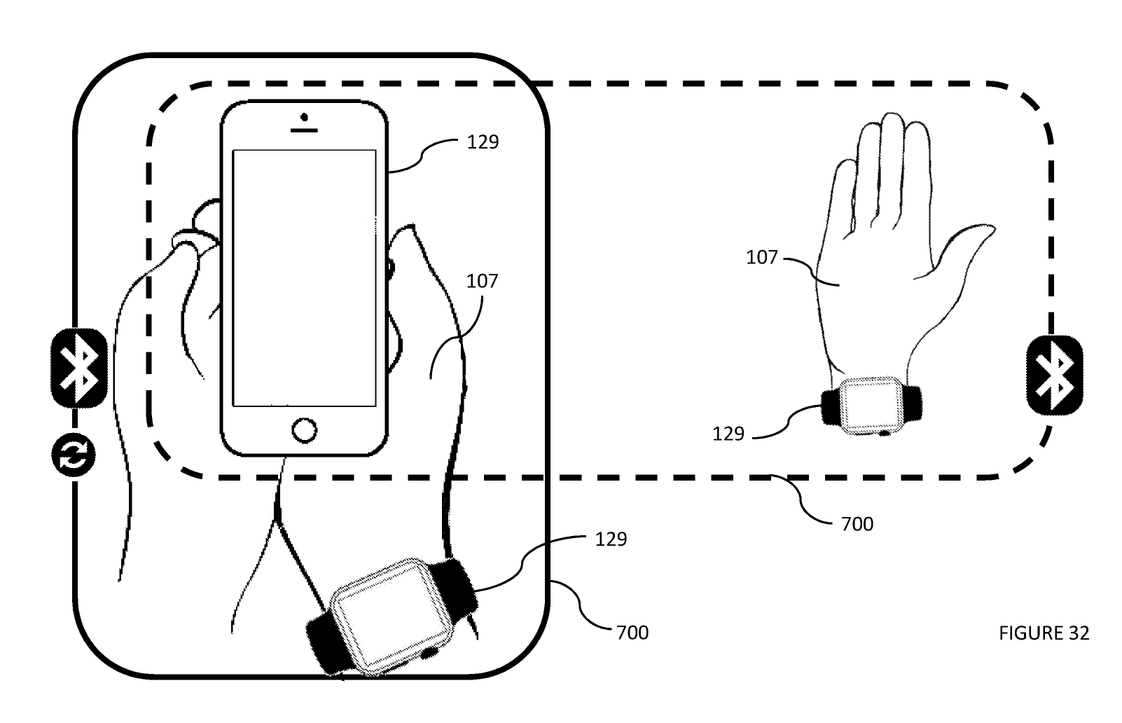

117 Data Credibility Scores—In one embodiment of the invention, Data Credibility Scores can be ratings giving to any Data Supplier 107 based on the results of the match and mismatch of Data Points 103 and interactions with the Data Source Validation Methods 415 and Nullification Methods 416. The rating can be numerical (e.g. 82%, 47%), alphabetical (ex. A+, B−, C, F−), and/or a combination of the two. The mathematical algorithms can be, e.g., based Bayesian credibility and Balmann credibility. Under an Bayesian model of Actuarial Credibility, a sample of the weighted averages the Data Set/s's 101 match/mismatch, Data Source Validation Methods 415 interactions, and Nullification Methods 416 interactions. Data Supplier/s 107 with high Data Credibility Score can command a price premium, receive rewards, and prequalified for new Data Deals 102. In contrast, Data Supplier/s 107 with low Data Credibility Score can be ignored and/or discounted and/or and pre-disqualified from new Data Deals 102 to reduce time waste, processing power, and avoid rewarding bad data-producing behaviors, within the Payment Schedule Methods 420 and the Data Negotiation Parameters Methods 418. Data Credibility Score can change per Data Deal 102 due to the weighted averages of requested Data Sets 101 will differ from the Data Blocks 104 in each Data Deal 104. The Credibility Score can be used to filter Data Suppliers 107. Regardless of Data Credibility Score, if the Data Supplier 107 does not meet other filters 414, then the Data Supplier 107 cannot enter the Data Deal 102. If a Data Deal 102 requires that the Data Suppliers 107 are of female gender and over 40 years age, then any males Data Suppliers 107 under the age of 30 years are filtered 414 out of the Data Deal 102, even if males Data Suppliers had perfect Data Credibility Score. When the Data Source Validation Methods are enhanced with Proximity Account Switching 700 and Proximity Data Tier Grading 800, Data Credibility Score can improve in accuracy and precision as seen in FIGS. 32 to 34.

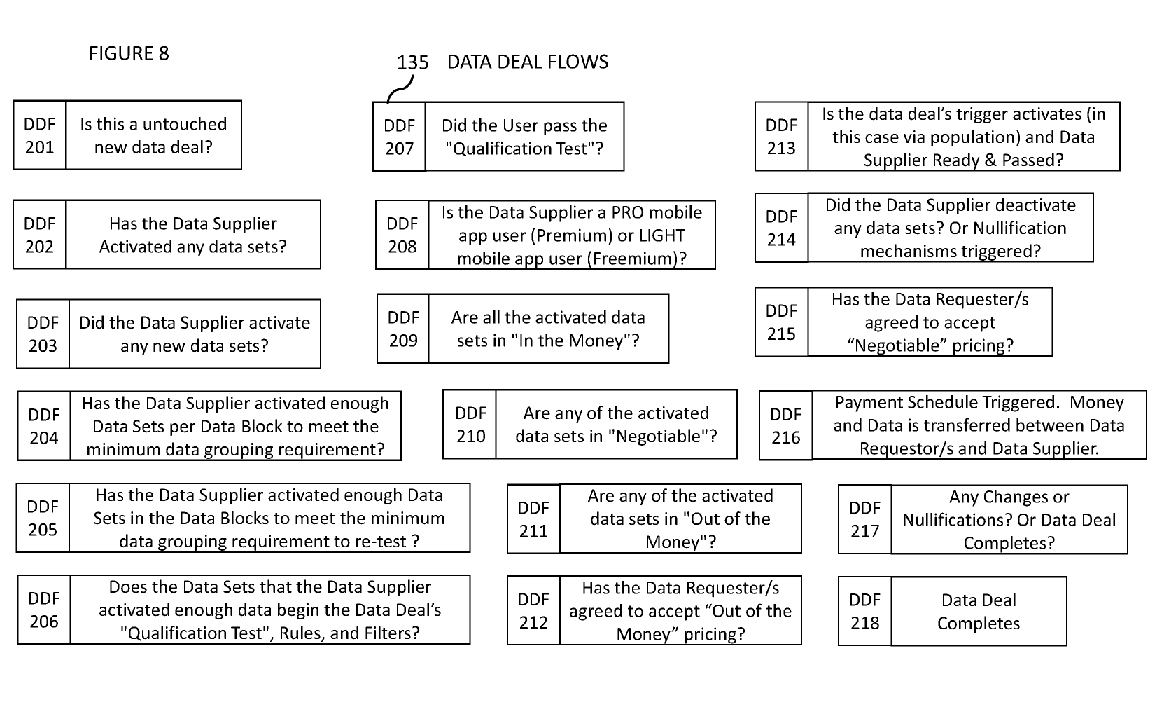

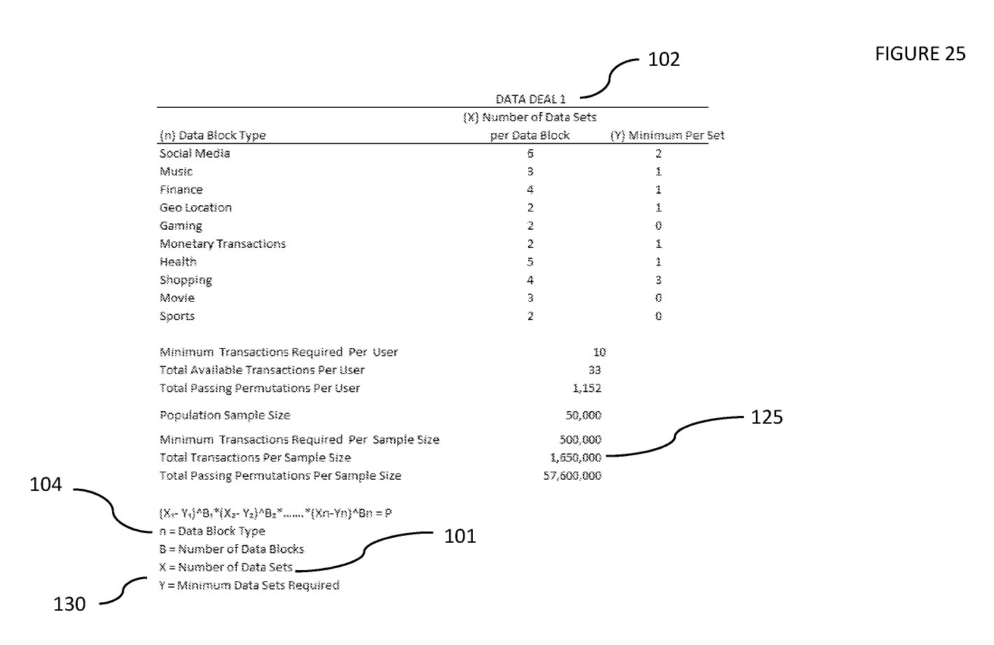

125 Multi-Dimensional Multi-Source Data Requests—In one embodiment of the invention, request for a plurality of Data Sets 101 from competing data sources, independent data sources, and/or unrelated data sources to each other from related or unrelated categories, industries, and/or sectors. This can happen when a Data Requester 106 requests a diverse group of Data Sets 101 like Facebook (Social Media Source), Google+ (Competing Social Media Source), iTunes (Music Source), Pandora (Competing Music Source), Experian (Finance Source), Google Map (Geo Location Source), PokemonGo (Gaming Source), Money Gram (Monetary Transaction Source), Fitbit (Health Source), Amazon (Shopping Source), Firefox (Click Stream Source), Netflix (Movie Renting Source), and ESPN (Sports Source). In 2016, according to GlobalWebIndex's quarterly report on the latest trends in social networking, the average internet user has 8 social media accounts from 50 social media applications selected. And, in 2016, according to Tech Crunch, 23% of mobile app users abandon a new app after the 1st use. The complexity may increase when those customers do not use the same data-producing sources or a combination of data-producing sources, such different browsers (ex. Chrome vs Safari; Chrome and Firefox), diverse social media apps (ex. Facebook vs Snapchat; Snapchat & Instagram), shopping mediums (Amazon vs Alibaba; eBay and Amazon), dissimilar search engines (Bing vs Google Search; Bing and Google), diverse financial apps (PayPal vs Apple's Wallet; PayPal and Visa NOW app), different health apps (Fitbit vs. Health; Fitbit and Nike+) and so for. In the flux of the Information Age, Data Requests naturally ask for multiple competing Data Sets to 101 create redundancy to account for abandonment, to improve data integrity, and/or to balance the fact that not all of Data Suppliers 107 have the same Data Sets 101. Addition to the transactional complexity, Data Suppliers 107 can have multiple UEs 129 for affluent Data Suppliers 107, which may own an iPhone, an iWatch, a Samsung Galaxy for work, a Laptop, a Desktop and more. Or, the inverse, multiple Data Suppliers 107 share the same UE 129 can reduce the quality of the data produce. Low income houses can share the same UE 129. Consequently, by adding diversity, redundancy, and unique relationships between Data Suppliers 107 and UE 129, in mathematical terms, a Multi-Dimensional Multi-Source Data Requests produces a large amount of data transactions and permutations to be brokered and managed simultaneously as shown, e.g., in FIG. 25 and FIG. 8.

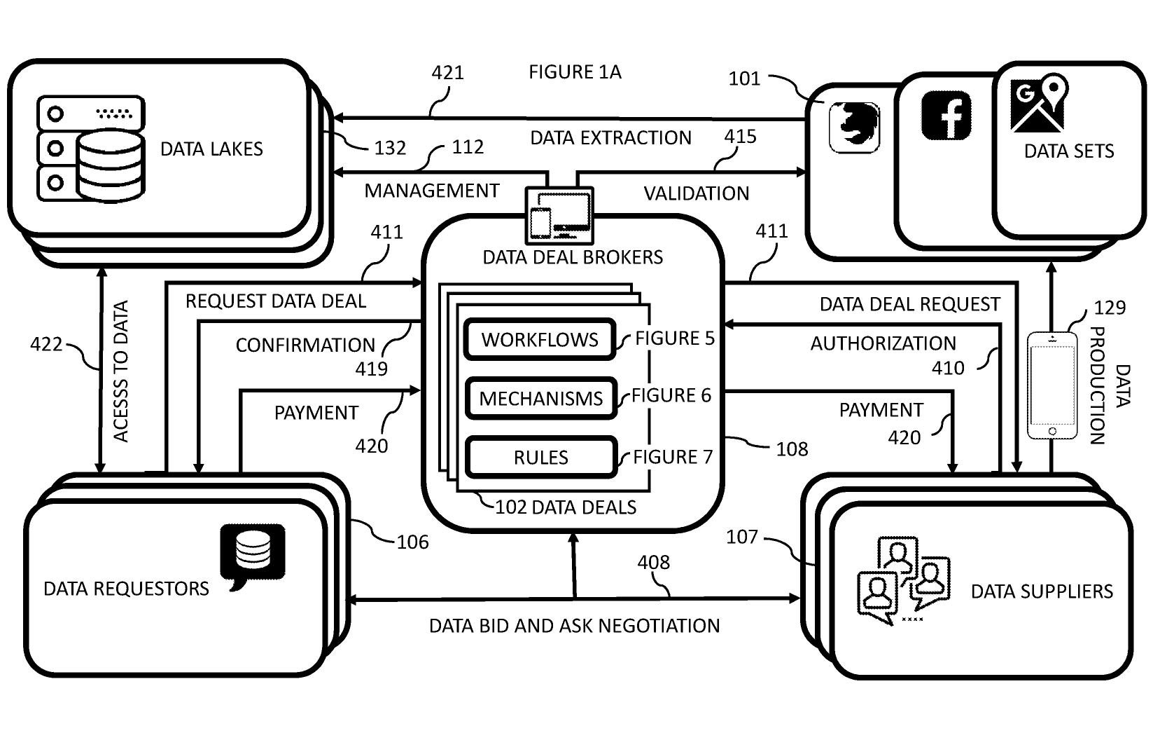

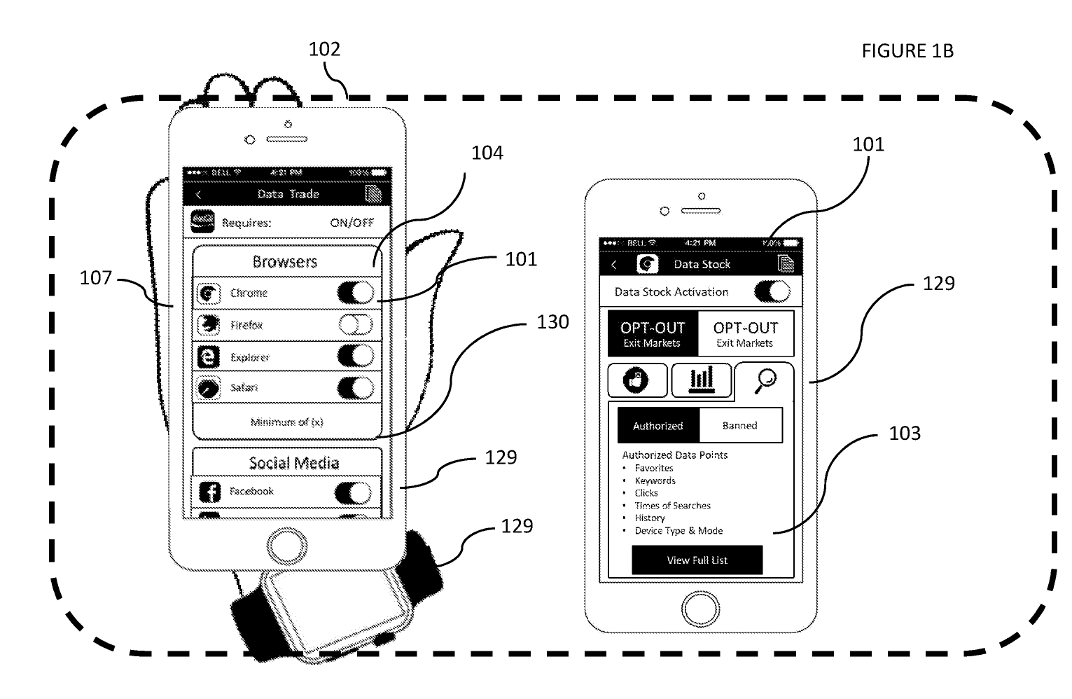

129 (UE) User Equipment—In one embodiment of the invention, UE are Mobile Phones, Personal Computers, Smart Phones, e-wearables (ex. AppleWatch, Fitbit bracelet), and portable electronics with standard online and offline features. It is assume that an UE contains an embodiment of the invention or can access an embodiment of the invention via interactive user interface (mobile app, browser, desktop app, etc. . . . ) in order to appreciate the benefits of invention as in FIG. 1. Data Suppliers 107 produce data when using their UE for their respective Data Sets 101, which when validated via the Data Source Validation Methods 415, and extracted via the Data Extractions Methods 421. Most of these transactions will be managed and monitored by the Data Deal Portal 112. Data Suppliers 107 normally have access to an UE 129. In affluent countries, a Data Supplier 107 can have multiple UEs. In less affluent countries, such as Third World countries, Data Suppliers 107 of those location may share a UE with other Data Suppliers 107. In the majority of scenarios, Data Supplier 107 will produce data via a UE and additional Multi-Dimensional Multi-Source Data Requests 125 are created due to the user to UE relationships. The UE may belong to a Data Requestor 106 (subsidized), contracted (via Internet Provider or Telecom Company), shared between Data Suppliers 107, and/or sole owned by the Data Supplier 107 (an individual). Sometimes throughout this application, we may refer to an iPhone as an example of UE since it is currently one of the most popular UE. This should not be seen as limiting.

130 Data Block Minimum Requirement—In one embodiment of the invention, Data Block Minimum Requirements 130 can be a set of rules to ensure that an expressed minimum Data Set 101 number with a Data Block 104 are met before activating the Data Deal 102. This rule can allow Data Requestor/s 106 to add redundancy of Data Sets 101 and improve data integrity to the Data Deals 102 that the Data Requester/s 106 would enjoy.

131 Data Markets—In one embodiment of the invention, Data Markets are a grouping of Data Deal/s 102 viewed in an UE 129 that allows the Data Suppliers 107 to view, monitor, control, and/or drill down monetary gains from all Data Deals 102 that the Data Deal Brokers 108 are offering to participate and the status of each Data Deal 102 relative to the Filter Mechanisms 411 and the Data Supplier/s's 107 criteria. If a Data Suppliers 107 does not meet the Data Requestor 107 filters 411, then the system,

132 Data Lakes—In one embodiment of the invention, Data Lakes are environments that store and manage the data brokered by the Data Requestors 106 from the Data Suppliers 107 via the Data Deals 102. The Data Lakes are managed by the Data Deal Brokers 108 via Data Deal Portal 112 and interact with several of the mechanisms such as the Data Extraction Methods 421, Data Transfer Method 422, Data Treatment Method 423, and Data Blocking Methods 424. Data Lakes can be stored in traditional server clusters or in decentralized P2P Network Devices for storage.

133 External Data—In one embodiment of the invention, External Data is data that is any owned, produced, and/or gathered by the Data Requesters 106 outside of a Data Deal 102. This data was not produced by the Data Suppliers 107 in any Data Deal 102. However, External Data can be mixed in the Data Lakes 132 and re-brokered when a Data Deal 102 is used for a Secondary Market.

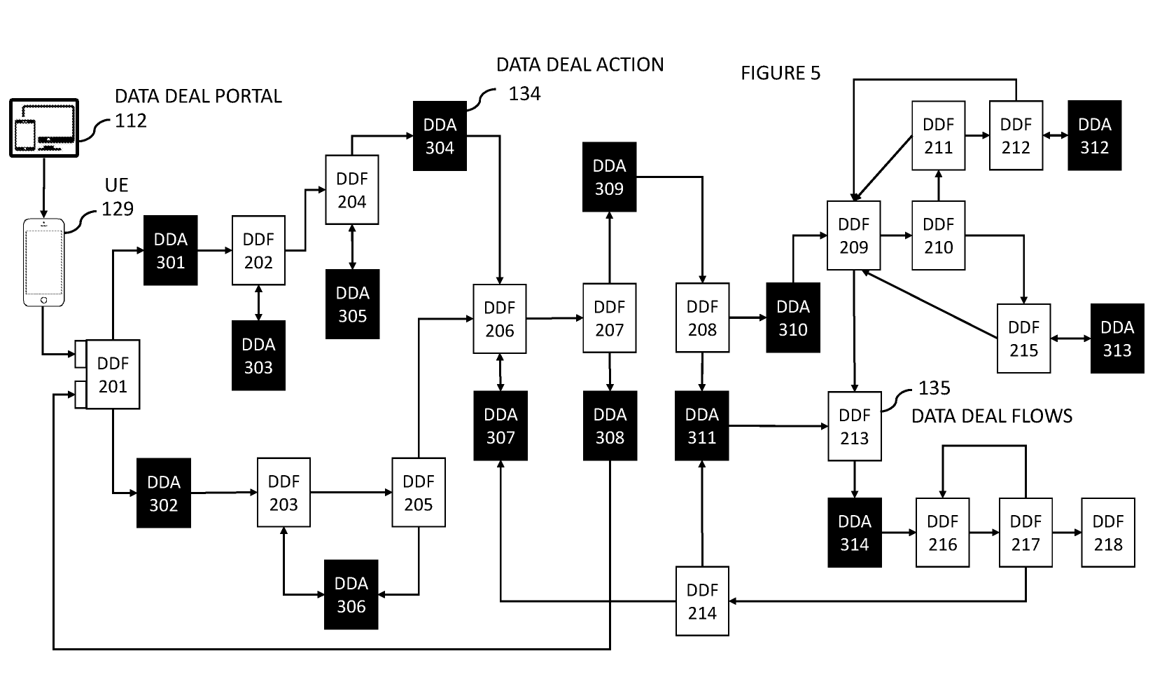

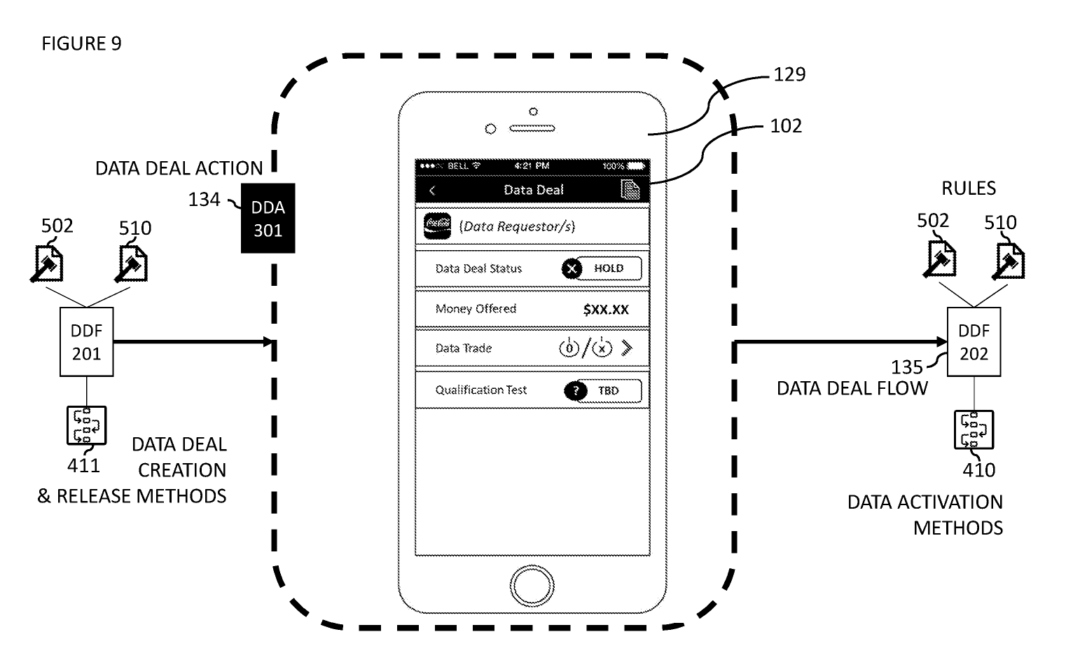

134 Data Deal Action—In one embodiment of the invention, a Data Deal Action are stages in the Data Deal 102 where Data Supplier 107 determines the next actions to become part of a focus group via UE 129. The results of previous Data Supplier's 107 input, Workflows FIG. 5, Mechanisms FIG. 6, and Rules FIG. 7 are processed prior to the next Data Supplier 107's set of inputs. Most of these transactions can be handled by the Data Deal Portal 112. FIG. 9 to FIG. 22 represent different Data Deal Actions.

135 Data Deal Flows—In one embodiment of the invention, a Data Deal Flows are the query decision points and control points inside a Data Deal 102, where the Data Suppliers' 107 input, Workflows FIG. 5, Mechanisms FIG. 6, and Rules FIG. 7 determine the which Data Deal Action 134 options will be offered to the Data Supplier 107 to perform. The Data Deal Flows expedite the on-boarding of the Data Suppliers 107 to the Data Requestor's 106 Data Deal 102 into focus group. Most of these transactions can be handled by the Data Deal Portal 112. A legend of a possible Data Deal Flows is depicted in FIG. 8. Data Suppliers 107 may be filters 414 out of the process.

410 Data Activation Methods—In one embodiment of the invention, these processes allow the Data Suppliers 107 to signal the Data Deal Brokers 108 to begin the testing the Data Supplier's credentials, and other terms and conditions required by law and best practices of data transfers. Upon activation, the Data Supplier 107 could be prompt to provide inputs and credentials associated with the Data Sets 101. Once validated via pings and test methods, Data Deal Brokers 108 with grants the Data Rights 109 as the legal rights to represent, protect, and/or broker the data grouping activated. Upon authorization completion, the Data Deal Brokers 108 activate Data Sets 101, Data Compositions 105, and other data groups by setting up Data Extraction Methods 421. A possible mechanism is via a toggle ON/OFF button. When a Data Sets 101 are activated, that data set activates for all Data Deals 102 that requested the same selected Data Sets 101. Thus, if 3 Data Deals 102 request the Data Sets 101 of Chrome from a Data Supplier 107 that activates their Chrome Data Set 101 will simultaneously activate that same Data Set 101 on all 3 Data Deals 102. Deactivation inverse the process. Data Suppliers 107 can exit any particular Data Deal 102 in multiple ways to include not agreeing to the terms and conditions of the Data Deal 102.

411 Data Deal Creation & Release Methods—In one embodiment of the invention, Data Deal Creation & Release Methods are these mechanisms that the Data Deal Brokers 108 use to create and group data from the Data Deal Portal 112. Data Points 103 to a Data Sets 101. Data Sets 101 into Data Blocks 104. Data Blocks 104 into a Data Deal 102. Data Deal/s 102, external data 133, and/or Data Compositions 105 into a secondary market Data Deal 102.

414 Data Deal Filters Mechanisms—In one embodiment of the invention, Data Deal Filters Mechanisms are mechanisms where the Data Requester/s 106 can request filters 414 for their respective Data Deals 102. These filters determine which Data Supplier/s 107 qualify for their respective Data Deal 102 and which Data Supplier/s 107 do not. The Data Deal Brokers 108 will analyze the respective Data Points 103 of each activated Data Set 101 and test if the Data Supplier 107 meets the criteria of the selected filters. Filters can be Demographical, such as gender, education level, minimum age, maximum age, dwelling type, occupation, ethnicity, employment status, and more. Filters can be Geographical by country, countries, zip codes, and/or zip code proximity. Filters can be Behavioral driver where specific criteria of Data Point/s 103 from requested Data Set/s 101 can be demanded. Filters are Data Credibility Scores 117, which determine the quality of a Data Supplier's 107 data. These filters can be applied to any Data Supplier 107 to select Data Suppliers 107 that have, e.g., Amazon (the Data Set 101) Purchases (the Data Point 103) higher than $100 (set criteria) with a Data Credibility Score 117 of 80%. An example of a filter for a Data Point 103 owned by a Data Supplier 107 can be a Netflix (the Data Set 101) Session Durations (the Data Point 103) higher than 5 hours per week (set criteria) with a Data Credibility Score 117 of 65%. Data Deal Brokers 108 can determine selection methods to onboard as many Data Suppliers 107 unto the Data Deal 102 in order to trigger 419 the Data Deal 102. The Data Deal Filter Mechanism can includes onboarding selection methods of the Data Suppliers 107 such as hierarchical ranking, LIFO, FIFO, prioritize by High Data Credibility Score 117, by lowest price bidder, basic sorting, and/or more.

415 Data Source Validation Methods—In one embodiment of the invention, Data Source Validation Methods are authentication methods to validate if the Data Supplier/s's 107 credentials are correct, if the account is real, and assist the evaluation of a Data Supplier's 107 Data Credibility Score. Data Supplier/s 107 can input their credentials (ex. user name and password). The Data Source Validation Methods 415 pings the account/s and/or application/s, tests if the credentials are correct or incorrect. This control notifies the Data Supplier/s 107 if human error is present for the Data Supplier 107 to troubleshoot. The next test could be if the account is real. If the account does not match the Data Supplier 107 such as name discrepancies (Dan Smith vs Susan B. Richards), geolocation discrepancies (India vs. Spain), activity discrepancy (human action vs robotic script), use of aliases or nicknames (Thomas Allen vs. Big T [nickname]), multiple emails (Personal Emails vs Work Emails), simultaneous use of the same accounts (Father and son using the same Chrome account in different devices), and more. If the account and/or application is correct and real, the Data Set 101 is activated. If the account fails, the Data Supplier/s 107 are notified. The number of discrepancies and types affect the Data Supplier's 107 Data Credibility Score 117. When enhanced by Proximity Account Switching 700 and Proximity Data Tier Grading 800 methods, the Data Suppliers' 107 Data Credibility Score can be improved, validated, and retargeted in inaccuracy and precision of the data produced from the Data Sets 101 as seen in FIGS. 32 to 34.

416 Nullification Methods—In one embodiment of the invention, Nullification Methods can mechanisms, such as scripts and rules, that nullify a Data Supplier/s' 107 Data Set/s' 101 payment based on activity ranges and affect the Data Supplier's 107 Data Credibility Score 117. An abandoned account and/or abandoned application can provide some useful information about the Data Supplier 107. For example, a Data Supplier 107 that does not purchase essential house hold items such as water and hygienic products may express the behavioral patterns of the Data Supplier 107. Even a Data Supplier\s' abandoned account and/or a Data Supplier\s' abandoned application can provide some consumer behavior insight. For example, if a Data Supplier 107 abandons using their Facebook account, then that Data Set 101 will have some value. However, Data Requester 106 can find this situation unfair to pay full price for Data Set/s 101 with little or no Data Points 103 within, even if fully validated by the Data Source Validation Methods 415. Thus, the nullification rules and scripts are set to reduce the settled price of the Data Sets 101 in the Data Deal/s 102. And if required, the Data Deal Brokers 108 can fully disqualify Data Suppliers' 107 Data Set/s 101 from the Payment Schedule Methods 420 to the related Data Deal/s 102. The Data Deal Brokers 108 control the Nullification Methods and set nullification parameters in the Data Deal Portal 112. The parameters are related to the production of Data Points 103 within the specified Data Set 101.

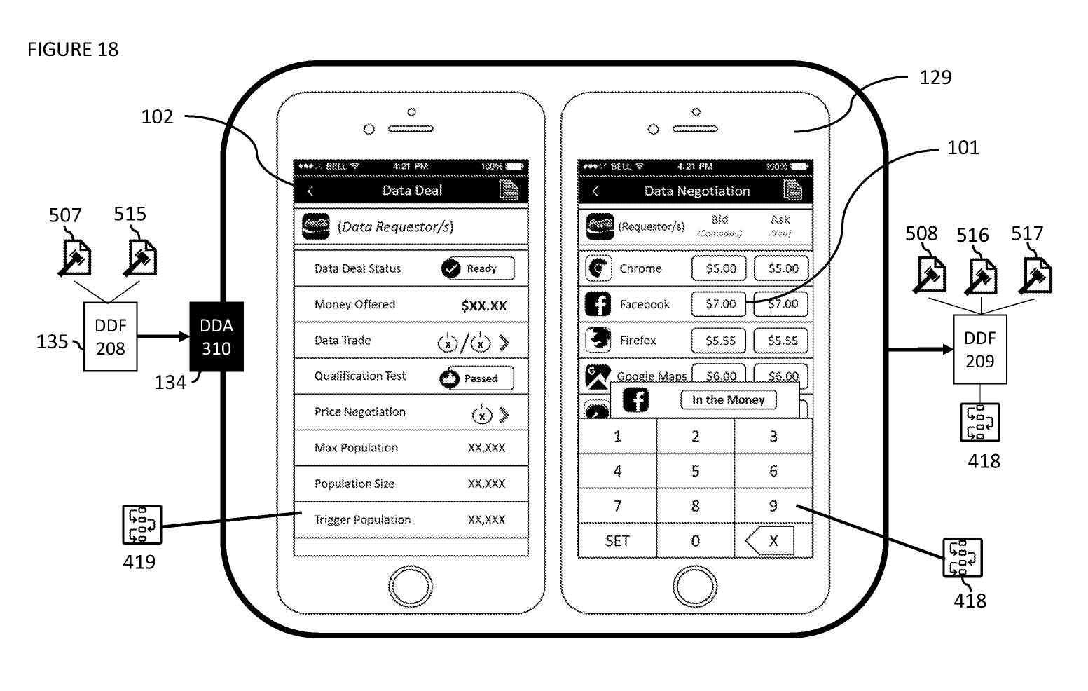

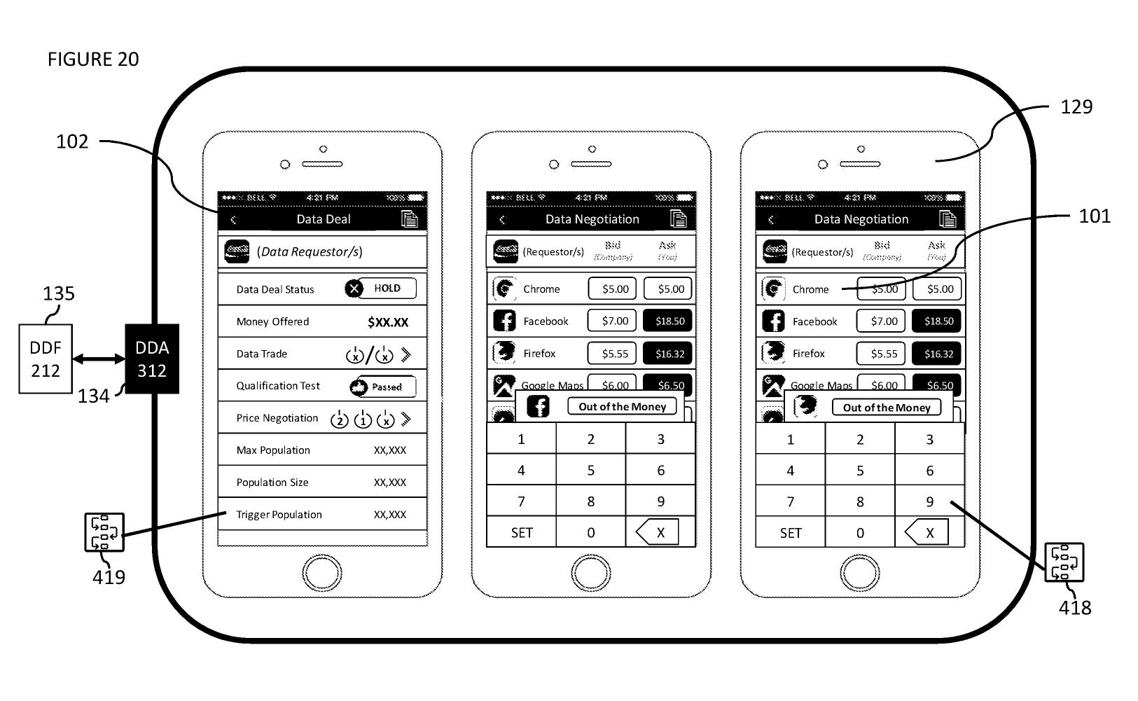

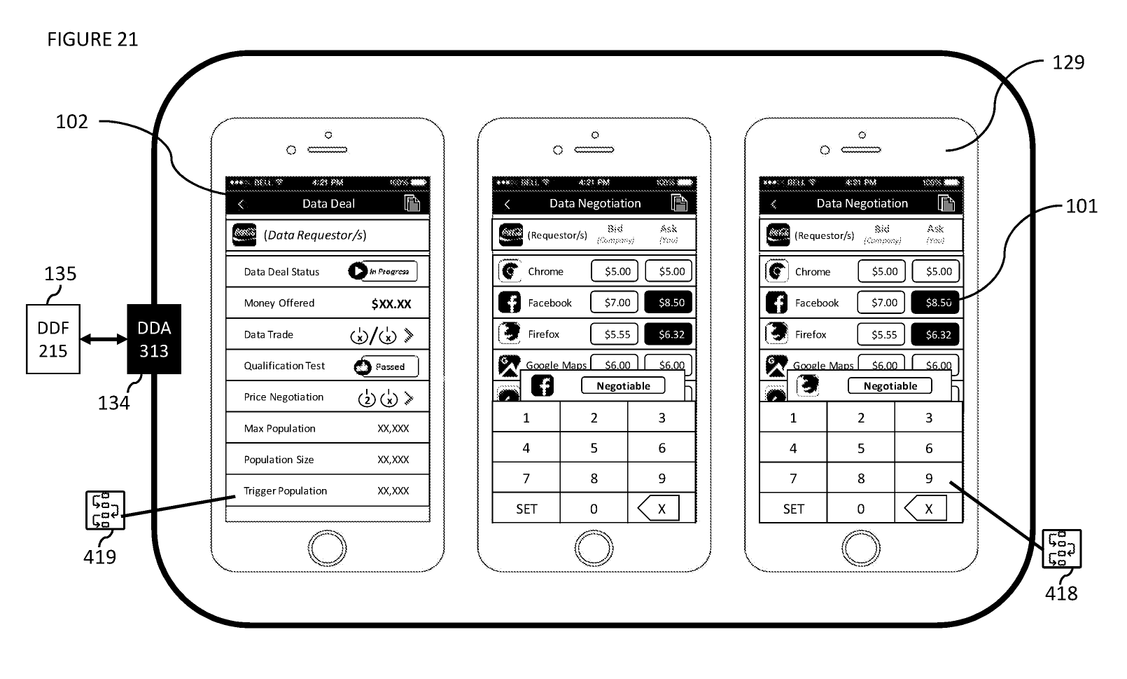

418 Data Negotiation Parameters Methods—In one embodiment of the invention, Data Negotiation Parameters Methods can be the pricing parameters set for the Data Sets 101, Data Deal 102 (ex. All-or-Nothing Data Deals), and/or other elements (ex. Data Blocks 104, Data Compositions 105, Data Point 103, etc. . . . ) by Data Deal Brokers 108 for the Data Requester/s 106 to the Data Supplier/s 107 within the Data Deal 102. For a ‘per Data Set 101’ case usage, Data Requesters 106 set and reset their starting bid, highest bid, and lowest bid per Data Set 101. Data Supplier/s 107 can view the Data Requester/s' 106 starting bid for each Data Set 101. If the Data Supplier 107 is at or below the starting bid for that particular Data Set 101, then the Data Supplier 107 is ‘In the Money’ for that Data Set 101 as shown in FIG. 18. If the Data Supplier/s 107 is above the starting bid, but within the highest bid, then the Data Supplier/s 107 receives a ‘Negotiable’ status for that Data Set 101 as shown in FIG. 21. If the Data Supplier/s 107 is above the starting bid and above the highest bid, then the Data Supplier/s 107 is ‘Out of the Money’ status for that Data Set 101 as shown in FIG. 20. Depending on the need, the Data Requester/s 107 can modify the parameters to include to increase or slow the onboarding of Data Suppliers 107 into a Data Deal's 102 population. These changes in the Data Requestors' parameters can speed up or slow down the triggering of their Data Deal 102 in accordance with the Data Deal Triggers Methods 419. This mechanism can have several features to supplement like signals (ex. color schemas), prompts (ex. pop-ups), recommends (ex. average pricing index), and, even to auto-adjusts (ex. an ‘index-style pricing auto follow’ widget) to the price of the Data Sets 101. A scenario to speed up would be to modify pricing parameters to accept ‘Negotiable’ bids for specific Data Sets 101 and reasonable ‘Out of the Money’ bids to begin data extraction as soon as possible. A scenario where Data Requester/s 106 want to slow down by reducing bids is if the Data Deal 102 is already triggered and additional Data Supplier/s 107 population only covers the attrition of current Data Supplier/s 107 that fail Data Source Validation Methods 415 and Nullification Methods 416 over time. FIGS. 18 to 23 show the mechanism working on a UE 129 for different Data Deal Actions 134.

419 Data Deal Triggers Methods—In one embodiment of the invention, Data Deal Triggers Methods are triggering mechanisms within a Data Deal 102 that activate a Data Deal 102 when that control limit is reached. At this stage, Data Requestors 106 and Data Suppliers 107 are have reach an agreement. Data Suppliers 107 provided authorization to the Data Deal Brokers 108, who have provided a confirmation to the Data Requestors 106. These triggers signal the Payment Schedule Methods 420 to execute. The triggers can be population-based, time-based, and/or data-based. The population-based triggers are possibly one of the most useful tools since large populations of individuals provide the best statistical sample size and real-time data. For example, in one implementation, a target market of 20,000,000 people with a confidence level of 99% and confidence interval of one requires only a sample size of 16,627 Data Requestors 107. Thus, in this scenario, the Data Requester/s 107 can choose to wait or modify to their pricing parameters to reach that sample size population and trigger the Data Deal/s 102. Time-based and data-based triggers can be used mainly for secondary market Data Deals 102 were the requested Data Deal/s 102, Data Compositions 105, and/or External Data 133 are already activated and/or in an environment collecting data.

420 Payment Schedule Methods—In one embodiment of the invention, Payment Schedule Methods and/or compensations are the mechanisms of transferring money and/or any other form of compensation from Data Requester/s 106 to Data Supplier/s 107. Methods can include down payments, auto payments, PayPal, direct deposit, and more including the allocation of vouchers, discounts, privileges, subscriptions or commercial merchandise. The timing and distribution of payments will depend on the Data Deal's 102 terms and conditions between the Data Requester/s 106 and the Data Deal Brokers 108. In one implementation, all payments are recorded and transacted with the Data Deal Portal 112, which can be seen in FIG. 35. This feature allows e.g. Data Supplier/s 107 to view, monitor, control, and/or drill down to all transfer actualized monetary gains from contracted Data Deals 102.

421 Data Extraction Methods—In one embodiment of the invention, Data Extraction Methods are the mechanisms to retrieval any Data Points 103 within an activated Data Set/s 101, Data Requester/s 107 internal information (external data), Data Compositions 105 and/or other sources from authorized environments as directed by the Data Deal 102. With the current Big Data technology, the data can be extracted in real-time data with software modules like Guavas or Spark Hadoop. Or the data can be collected as historical data in due time, which can be stored in the Data Lakes 132 and distributed by Data Transfer Methods 422. There are several known techniques, such as SOAP APIs, REST APIs, scripting, Cookies, basic uploading, and other common techniques. Other unique techniques can include dual transactions. This data retrieval technique will signal the authorized device and/or authorized Data Supplier's 107 data source to send 2 transactions: one to the destination sources and another to this destination assigned by Data Deal Brokers 108. With the credentials brokered by the Data Validation Methods 415, dual transactions and mimic scripts focus on retrieving Data Points 103 from the Data Set's 101 point of origin. These Data Extraction Method will be required from data sources that refuse to provide APIs, deny access, and/or other peaceful means to acquire data that was granted and agreed-on between the Data Deal Brokers 108, the Data Requester/s 106, and the Data Supplier/s 107. The Data Points 103 formatting (.csv, .json, .txt, or BI files [.twb, .pbix]) depend on the Data Requesters' 107 needs.

422 Data Transfer Methods—In one embodiment of the invention, Data Transfer Methods can be the mechanisms to distribute and store Data Points 103 from the Data Sets 101 per Data Set 101 per Data Supplier 107. These mechanisms expediting the delivery of data of the Data Deals 102 via the file/script libraries, commands, and destination environment storage. These Data Transfer Methods interact with the other methods (Data Extraction Methods 421, Data Deal Filters Mechanisms 414). Depending on the terms and conditions for sale, renting, and/or leasing, these mechanism can transfer the data to environments inside or outside the Data Deal Brokers's 108 controls and respective Data Lakes 132. Under renting conditions, the likely scenario provides access to those Data Lakes 132 within the control of the Data Deal Brokers 108. Data Deal Brokers 108 use the Data Deal Portal 112 to manage the Data Transfer Methods system.

423 Data Treatment Methods—In one embodiment of the invention, Data Treatment Methods are methods and mechanisms for enacting data enhancement techniques to include metadata tagging, anonymization, encryption, taxonomy allocation, categorization, data compression, file formatting, and other data treatments to the Data Points 103 from activated Data Sets 101, primarily inside the Data Lakes 132.

424 Data Blocking Methods—In one embodiment of the invention, Data Blocking Methods are the features in the Data Extraction Methods 421 that can execute the stoppage of any unauthorized transactions and distributions granted by the Data Rights 109 per Data Sets 101. Data Blocking Methods are controlled by the Data Deal Brokers 108 and executed via the Data Deal Portal 112. Data Blocking Methods can be internal within the system to stop any data leaks with the system, delete data from Data Deal 102 under a rental format where Data Requesters 107 stopped paying, and/or external from the system to stop unauthorized 3rd parties from stealing Data Points 103. Blockage Techniques include denial of service requests, automatic information “opt-out” requests on behalf of clients to 3rd parties, removal of spybots from devices, etc. . . . .

700 Proximity Account Switching—In one embodiment of the invention, Proximity Account Switching is one of the novel features that can enhance the Data Source Validation Methods 415 by directly increases the quality of the of the Data Points 103 in the Data Sets 101 via switching the account between Data Suppliers 107 based on UE 129 proximity. This is based on the proximity of the device between Data Suppliers 107 and other users with a UE 129 that handle the same primary UE 129. Upon which trading the UE 129 between Data Supplier 107, the Data Suppliers' 107 accounts are switched and the data production associated to the correct ownership tagging. A simple scenario is two friends (Data Suppliers 107) using the same iPhone (UE 129) to share different songs via iTunes, Spotify, Pandora, and YouTube (Data Sets 101). This feature will track those manual transfers of UE 129 between the two Data Suppliers 107, which can improve the quality of the Data Points 103 in the Data Sets 101. Such changes in the Data Suppliers 107 directly affect the Data Credibility Scores 117. This technology enhancement can be deployed in a Data Deal 102 by simple Bluetooth and/or other methods. The Data Suppliers 107 would be required to be in a Data Deal 102. FIG. 32 displays a basic diagram of a User Equipment (an UE 129) and two different AppleWatches (UE 129 e-wearables) who have handled and interacted with the same device. In addition, researchers observered that low income families and, at times, whole villages in Third World countries would use a single smart device (an UE 129) between individuals, groups, collectives, and other smart-phone-sharing arrangements. Since smart e-wearables are cheaper to produce than smart phones due to lesser material costs (an AppleWatch is smaller than e.g. an iPhone 7) and durability-minded (ex. water resistant up to 300 feet underwater), the ratio of e-wearables to smart devices will increase. Even the Data Suppliers' 107 e-prosthetics or “Under the Skin” e-wearables, like a smart RF-ID chip, can be within scope.

800 Proximity Data Tier Grading—In one embodiment of the invention, Proximity Data Tier Grading is one of the novel features that can enhance the Data Source Validation Methods 415 that directly increases the quality of the Data Points 103 in the Data Sets 101 via constantly ranking the data produced by any UE 129 against the proximity of the Data Supplier 107 to the data producing UE 129. This feature tracks and ranks the distance between data production in the UEs 129 handled by the closest Data Supplier 107 in a Data Deal 102. The method may require the EUs 129 share and measure the known location of two known GPS-enabled two EUs 129 (ex. iPhone and an iWatch) to triangulate the unknown location of any Data Supplier 107 in a Data Deal 102 at any point in time. A scenario is a Data Supplier 107 in a Data Deal 102 that leaves his or her UE 129 at home playing music of one of his Playlists on his/her Apple TV module and goes to the store for 3 hours. The phone is automatic playing music and thus no Data Supplier 107 is listening. As the UE 129 plays music, data produced and the distance between the Data Supplier's 107 UE 129 is metatagged and graded for quality review. The quality of the tier-grade-tagged Data Points 103 in the Data Sets 101 directly affect the Data Credibility Scores 117. Or the feature simply records the Data Supplier's 107 behavioral patterns for the Data Requestors consideration. This feature is based on the proximity between UEs 129 shared by a single Data Suppliers 107, which is measured a primary UE 129. Even Bluetooth radio technology disconnections and/or signal strength gauging can be used to measure the distance between any Data Supplier 107 and their respective EUs 129 for implementation of this feature.

### DETAILED DESCRIPTION OF THE DRAWINGS

An example embodiment of the present invention and its potential advantages are understood by referring to FIGS. 1 through 36 of the drawings.

FIG. 1A represents a simplified possible schematic embodiment of the invention describing the method, system, and apparatus from zoomed out top level show. In this expression, the Data Requestors 106, Data Suppliers 107, and the Data Deal Brokers 108 interact with the system, methods, and apparatus in order to exchange data and compensation via a Data Deal 102. The Data Requestors 106 can request a Data Deal 102 from the Data Deal Brokers 108 via the Data Deal Creation & Release Method 411. Each Data Deal 102 is unique and yet can share Workflows FIG. 5, Mechanisms FIG. 6, and Rules [FIGURE 7] with other Data Deals. Based on the Workflows FIG. 5, Mechanisms FIG. 6, and Rules FIG. 7, the Data Deal Brokers 108 will send the Data Deals 102 to the selected Data Suppliers 107 via Data Deal Creation & Release Method 411. The Data Suppliers 107 can authorize the Data Deals 102 via the Data Activation Methods 410. Once the Data Deal 102 meets all the requirements set by Workflows FIG. 5, Mechanisms FIG. 6, and rules FIG. 7 and negotiations 408 are settled, the Data Deal Trigger Methods 419 will signal the Data Brokers 108 that the Data Deal 102 has reached the desired control. The Data Deal 102 is ready to officially begin exchanging data and money between Data Suppliers 107 and Data Requestors 106. Upon triggering, the payments schedule will start compensating the Data Suppliers 107 via the Payment Schedule Methods 420. In return, the Data Requestors can gain access to the Data Sets 101 inside their respective Data Lakes 132 via the Data Transfer Methods 422. Data Suppliers 107 produces data when using a User Equipment (UE) 129 for their respective Data Sets 101, which can be validated via the Data Source Validation Methods 415, and extracted via the Data Extractions Methods 421. Most of these transactions will be managed and monitored by the Data Deal Portal 112.

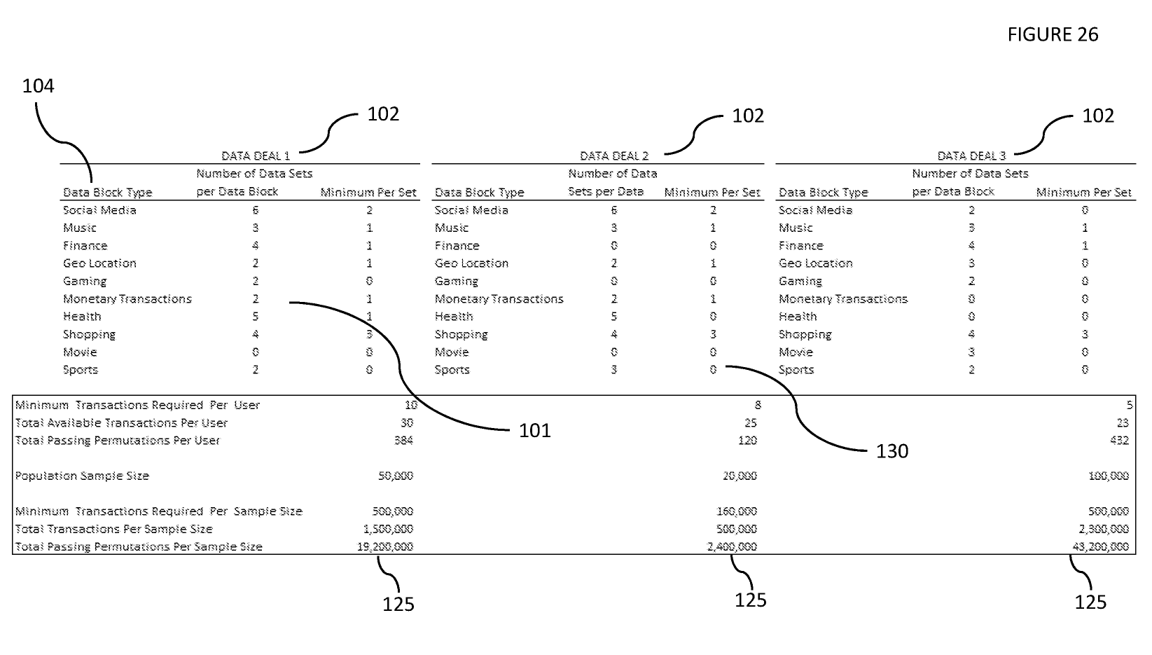

FIG. 1B represents a simplified possible schematic embodiment of the invention describing a system implementation wherein User Equipment (UE) 129 may belong to a data requestor (subsidized), contracted (via Internet Provider or Telecom Company), and/or owned by a Data Supplier 107 (the individual). UE 129 may have installed the Data Deal Portal 112 with an embodiment of the invention. UE 129 can enter the Data Deal Portal 112 with an embodiment of the invention via a remote portal browser like Chrome, Safari as examples. A user associated to a Data Supplier 107 account will appreciate that Multi-dimensional data requests 125 data sets organized into data groupings of Data Points 103 to Data Sets 101; Data Sets 101 to Data Blocks 104; Data Blocks 104 to a Data Deal 102. The example of the invention can be implemented via kind of data structure, such as multiple unrelated Data Blocks 104 with no minimum requirements 130 like the Data Deals 102 showed in FIG. 26.

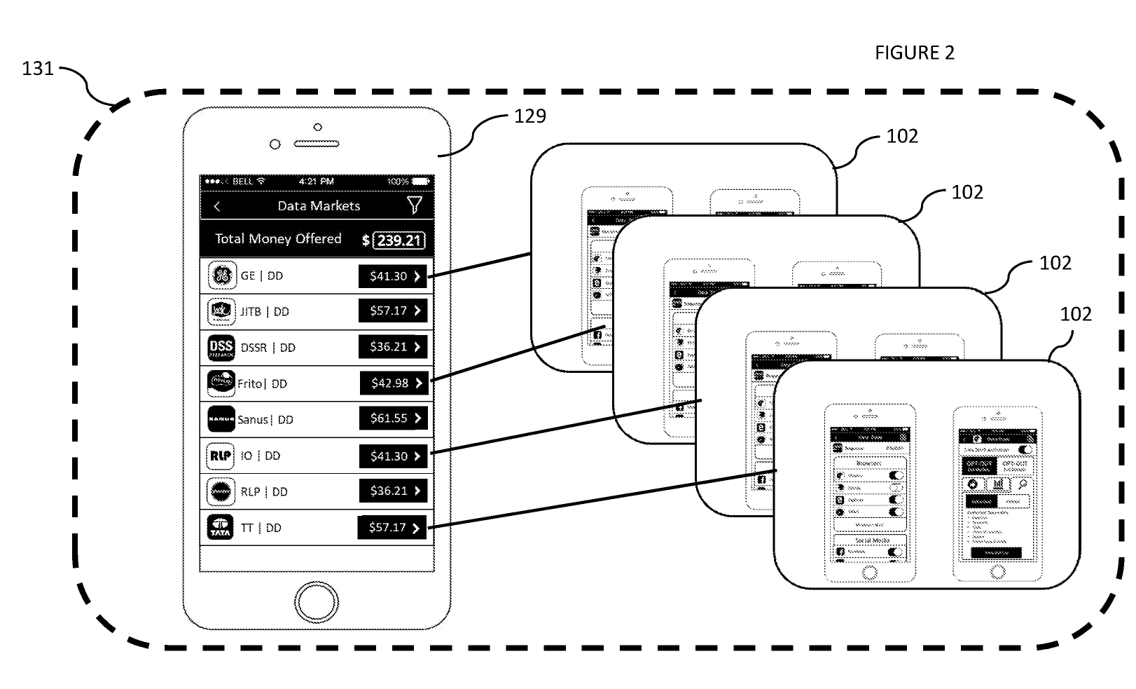

FIG. 2 represents a simplified possible schematic embodiment of the invention describing a system implementation wherein User Equipment (UE) 129 may belong to an Data Requestor 106 (subsidized), contracted (via Internet Provider or Telecom Company), and/or owned by the data supplier (the individual). UE 129 may have an installed version of the invention. Using a UE 129, the Data Supplier 107 can enter several Data Deals 102. Data sets are organized into data groupings of Data Deals 102 into a Data Market 131.

FIG. 3 represents a simplified possible schematic embodiment of the invention describing a system implementation wherein a Data Supplier 107 skilled in using an iPhone smart device (an UE 129) will appreciate adding External Data 133 (ex. Enterprise data like CRM SalesForce, ERP data, machine data) to combine the data from a grouping of Data Deals 102 to produce a Data Composition 105.

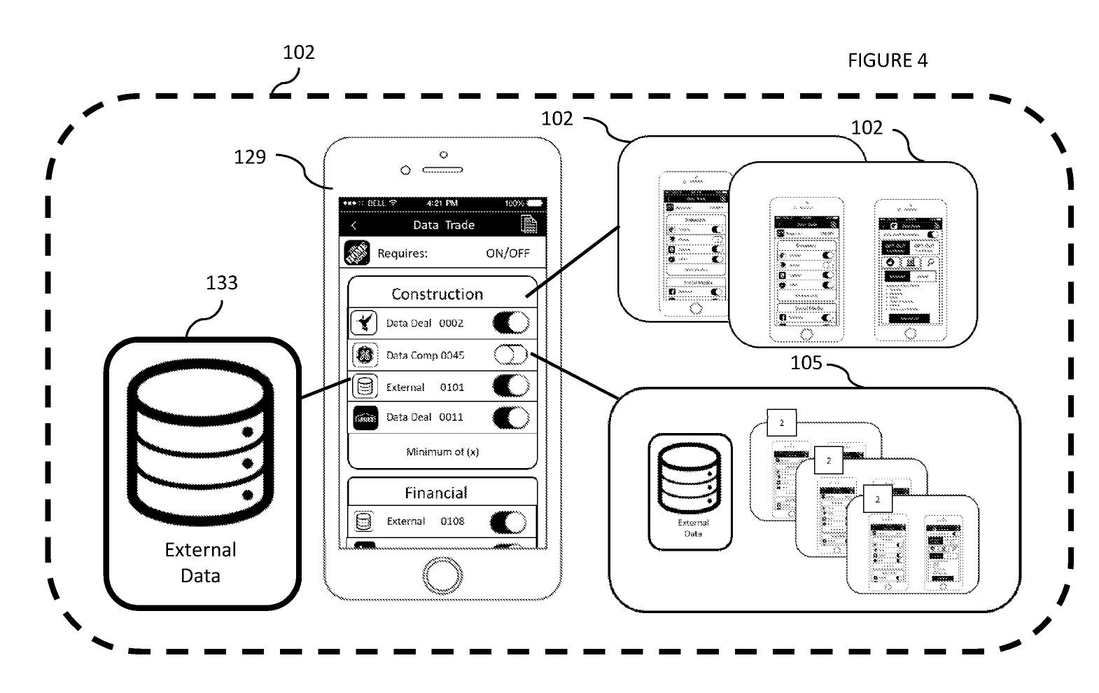

FIG. 4 represents a simplified possible schematic embodiment of the invention describing a system implementation wherein a Data Supplier 107 skilled in using an iPhone smart device (an UE 129) will appreciate further adding External Data 133 (ex. Enterprise data like CRM SalesForce, ERP data, machine data), Data Compositions 105, to combine the data from a grouping of Data Deals 102 into a Data Market 131 to produce a Data Deal 102. Note that a Data Deal 102 can be inside another Deal Deal 102. This is considered Secondary Market.

FIG. 5 represents a simplified and exemplary representation of workflow diagram; other possible workflow diagrams can be used for the invention describing a system implementation; in this case, a Data Supplier 107 via 129 receives Data Deal 102, which was sent via the Data Deal Portal 112. The Data Suppliers 107 can interact with the Data Deal Flows 135 (DDF). FIG. 8 is a legend, and Data Deal Actions 134 (DDA) FIGS. 9 to 22. The data in primary Data Deals 102 and secondary Data Deals 102.

FIG. 6 represents a simplified and exemplary representation of workflow diagram and mechanisms; other possible workflow diagrams can be used for describing a system implementation. In this case, a Data Supplier 107 via EU 129 receives a Data Deal 102, which was sent via the Data Deal Portal 112 and now displaying the mechanisms. FIG. 8 is a legend and the Data Deal Actions 134 (DDA) are all inside FIGS. 9 to 22. The method will further add steps to validate, extract, broker, treat, distribute, store, and payment flow of the data. The mechanisms in the process Data Deal Creation & Release Methods 411, Data Activation Methods 410, Data Deal Filters Mechanisms 414, Data Source Validation Methods 415, Nullification Methods 416, Data Negotiation Parameters Methods 418, Data Deal Triggers Methods 419, Payment Schedule Methods 420, Data Extraction Methods 421, Data Transfer Methods 422, and Data Treatment Methods 423. The mechanisms can be used Data Deals 102 with Data Set 101 main elements, while secondary Data Deals 102 can broker elements, such Data Compositions 105, multiple Data Deals 102, and more.

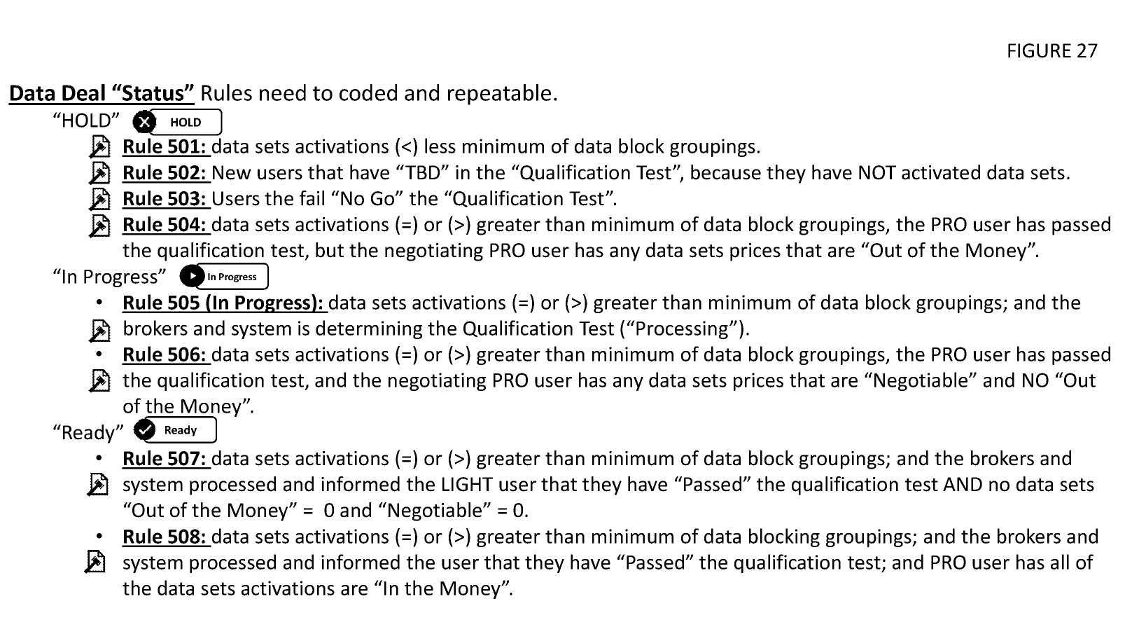

FIG. 7 represents a simplified and exemplary representation of workflow diagram and rule applications; other possible workflow diagrams can be used for the invention describing a system implementation; in this case, a Data Supplier 107 via 129 receives Data Deal 102, which was sent via the Data Deal Portal 112 and now displaying rules. FIG. 8 is a legend and the Data Deal Actions 134 (DDA) are all inside FIGS. 9 to 22 These methods, apparatus, and systems validate, extract, broker, treat, distribute, store, and payment flow of the data. The rules for each DDF 135 (501, 502, 503, 504, 505, 506, 507, 508, 509, 509T, 510, 511, 512, 513, 513T, 513P, 514, 515, 516, 517, 518, 519, 520, 521) are demonstrated on FIGS. 27 to 30.

FIG. 8 represents a simplified and exemplary representation of a legend for the Data Deal Flows 135; other possible interactive workflow diagrams can be used for the invention describing a system implementation; in this case, the Data Deal Flows 135 (Data Deal Flows: 201, 202, 203, 204, 205, 206, 207, 208, 209, 210, 211, 212, 213, 214, 215, 216, 217, 218) decisions points that determine if any mechanisms and/or rules demonstrated on FIGS. 27 to 30 requires implementation, executed, stopped, and/or adjusted.

FIG. 9 represents a simplified and exemplary representation of workflow diagrams, mechanisms, and rules; other possible workflow diagrams can be used for the invention describing a system implementation; wherein a Data Supplier 107 skilled in using an iPhone smart device (an UE 129) will appreciate interacting with a Data Deal 102. The starting DDA 301 (a Data Deal Action 134) show the Rule 502, Rule 540, and the Data Deal Creation & Release Methods 411 applying due to DDF 201(a Data Deal Flow 135). Once the DDA 301 reaches DDF 202, Rule 502, Rule 540, and the Data Activation Methods 410 will apply. The rules are demonstrated on FIGS. 27 to 30.

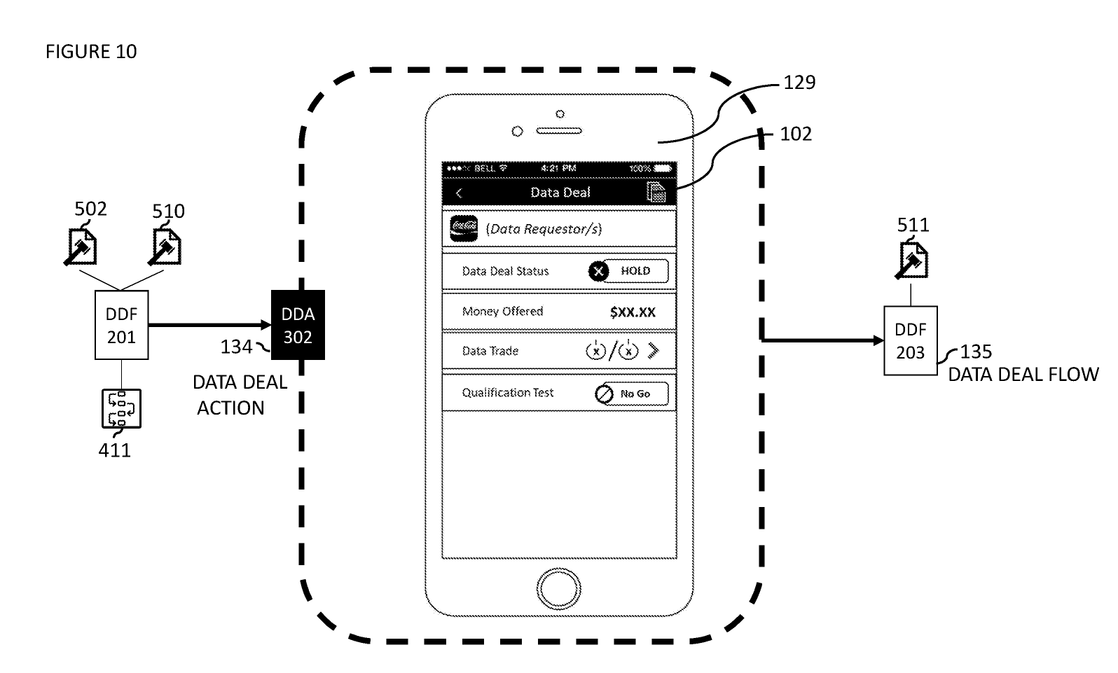

FIG. 10 represents a simplified and exemplary representation of workflow diagrams, mechanisms, and rules; other possible workflow diagrams can be used for the invention describing a system implementation; wherein a Data Supplier 107 skilled in using a smart device (an UE 129) will appreciate interacting with a Data Deal 102. The starting DDA 302 (a Data Deal Action 134) show the Rule 502, Rule 510, and the Data Deal Creation & Release Methods 411 applying due to DDF 201 (a Data Deal Flow 135). Once the DDA 302 reaches DDF 203, Rule 511 will apply. The rules are demonstrated on FIGS. 27 to 30.

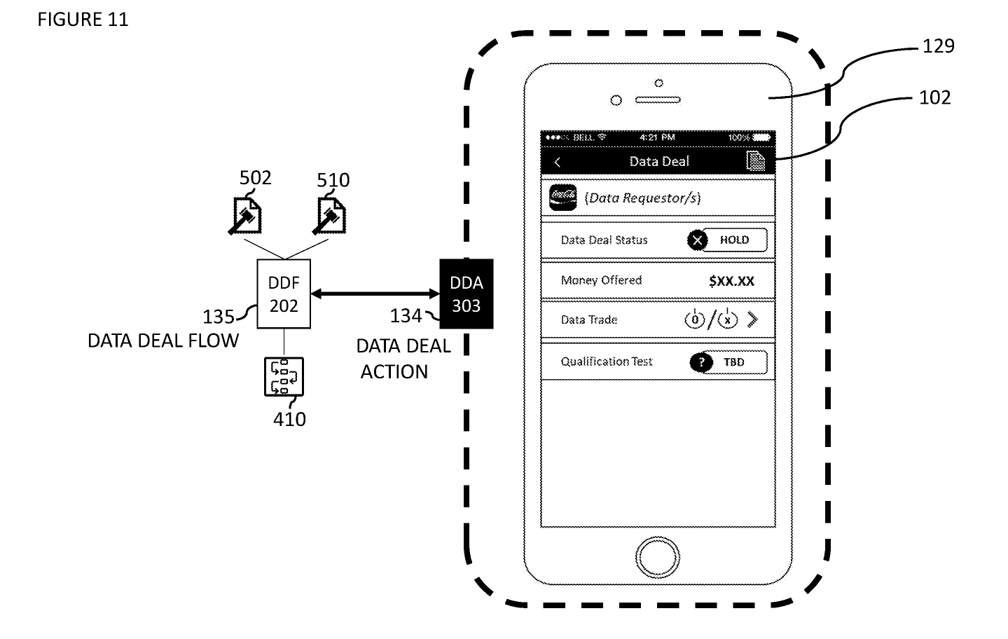

FIG. 11 represents a simplified and exemplary representation of workflow diagrams, mechanisms, and rules; other possible workflow diagrams can be used for the invention describing a system implementation; wherein a user associated with a Data Supplier 107 account and skilled in using a smart device (UE 129) will appreciate interacting with a Data Deal 102. The starting DDA 303 (a Data Deal Action 134) show the Rule 502, Rule 510, and the Data Activation Methods 410 applying due to DDF 200 (a Data Deal Flow 135). Until the DDA 302 passes and/or meets the requirements of the Rule 502, Rule 510, and/or the Data Activation Methods 410, then a Data Supplier 107 will remain on hold in the DDA 303 status. The rules are demonstrated on FIGS. 27 to 30.

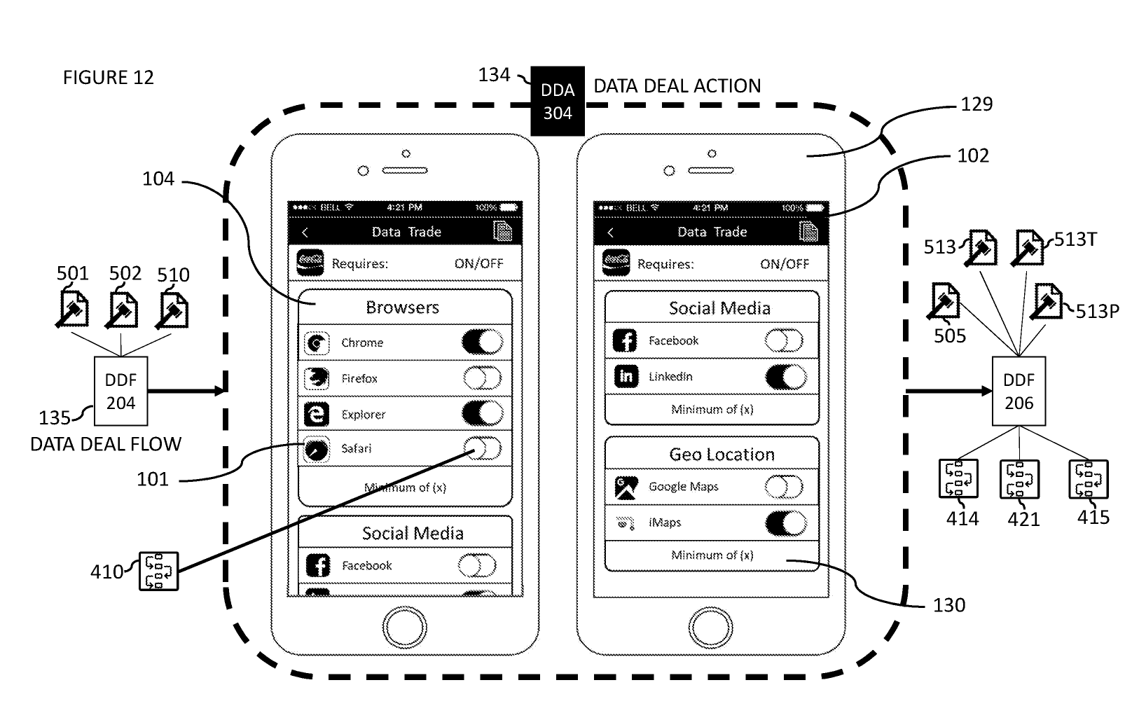

FIG. 12 represents a simplified and exemplary representation of workflow diagrams, mechanisms, and rules; other possible workflow diagrams can be used for the invention describing a system implementation; wherein a Data Supplier 107 skilled in using a smart device (an UE 129) will appreciate interacting with a Data Deal 102 and its elements like Data Sets 101, Data Blocks 104, and Data Block Minimum Requirement 130. The starting DDA 304 (a Data Deal Action 134) show the Rule 501, Rule 502, Rule 510, and the Data Deal Creation & Release Methods 411 applying due to DDF 204 (a Data Deal Flow 135). Once the DDA 304 reaches DDF 206, then Rule 505, Rule 513, Rule 513T, Rule 513P, Data Deal Filters Mechanisms 414, Data Source Validation Methods 415, and Data Extraction Methods 421 will apply. In addition, at this DDF Stage of the Data Deal 102, additional interphase starts displaying; in this case, Data Activation Methods 410. The rules are demonstrated on FIGS. 27 to 30.

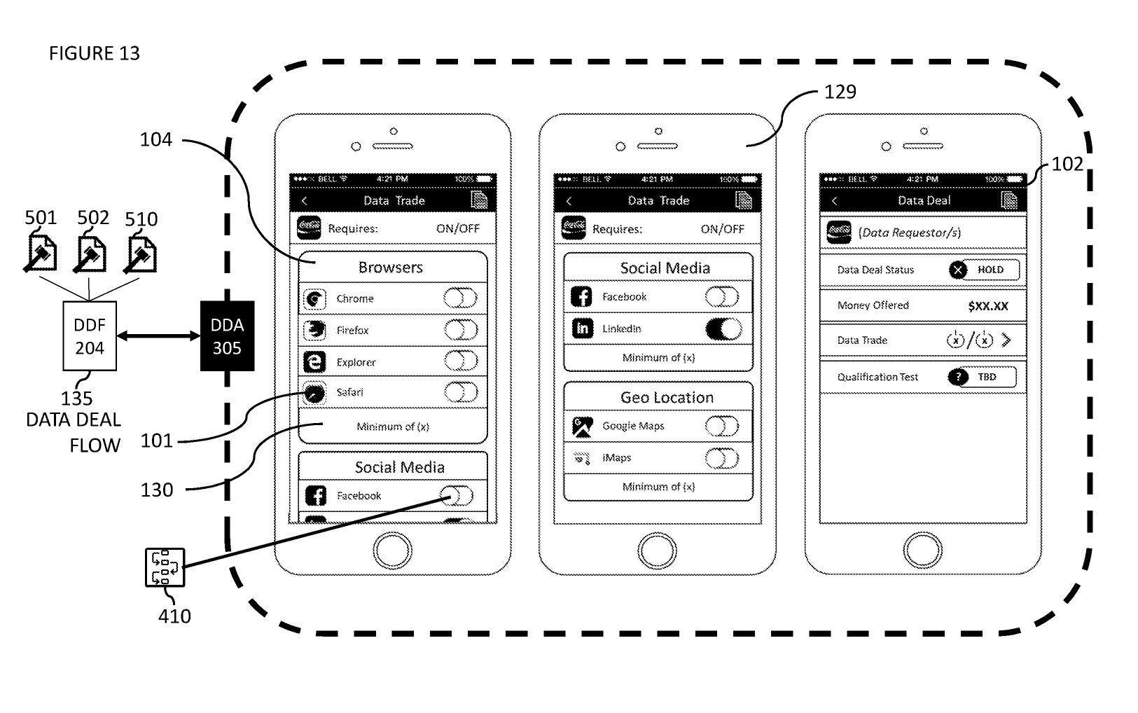

FIG. 13 represents a simplified and exemplary representation of workflow diagrams, mechanisms, and rules; other possible workflow diagrams can be used for the invention describing a system implementation; wherein a Data Supplier 107 skilled in using a smart device (an UE 129) will appreciate interacting with a Data Deal 102 and its elements like Data Sets 101, Data Blocks 104, and Data Block Minimum Requirement 130. The starting DDA 304 (a Data Deal Action 134) show the Rule 501, Rule 502, Rule 510, and the Data Deal Creation & Release Methods 411 applying due to DDF 204 (a Data Deal Flow 135). Once the DDA 304 reaches DDF 206, then Rule 505, Rule 513, Rule 513T, Rule 513P, Mechanism 414, Mechanism 415, Mechanism 415 will apply. In addition, at this DDF Stage of the Data Deal 102, additional interphase starts displaying; in this case, Data Activation Methods 410. The rules are demonstrated on FIGS. 27 to 30.

FIG. 13 represents a simplified and exemplary representation of workflow diagrams, mechanisms, and rules; other possible workflow diagrams can be used for the invention describing a system implementation; wherein a Data Supplier 107 skilled in using a smart device (an UE 129) will appreciate interacting with a Data Deal 102 and its elements like Data Sets 101, Data Blocks 104, and Data Block Minimum Requirement 130. The Data Supplier 107 will be able to interact with the Data Blocks 104 by activating or deactivating Data Sets 101. The starting DDA 305 (a Data Deal Action 134) shows the Rule 501, Rule 502, and Rule 510 applying due to DDF 204 (a Data Deal Flow 135). Until the Data Supplier 107 activates enough Data Sets 101 to meet the Data Block 104 requirements and the rules (Rule 501, Rule 502, and/or Rule 510), the Data Deal 102 will remain on hold in the DDA 305 status. In addition, at this DDF Stage of the Data Deal 102, the Data Deal 102 and Data Activation Methods 410 interacting, which is one of the mechanisms that reduces Multi-Dimensional Multi-Source Data Requests 125. Each Data Set 101 activated by the Data Supplier 107 can interact with other Data Deals 102 by auto activating due to the fact that Data Requesters 106 will like request the same data from that Data Supplier 107 in multiple Data Deal 102. Data Requestors 106 can set Data Block Minimum Requirement 130 to increase the data quality by creating redundancy on data gaps created by multi-usage and timings between Data Sets 101. The rules are demonstrated on FIGS. 27 to 30.

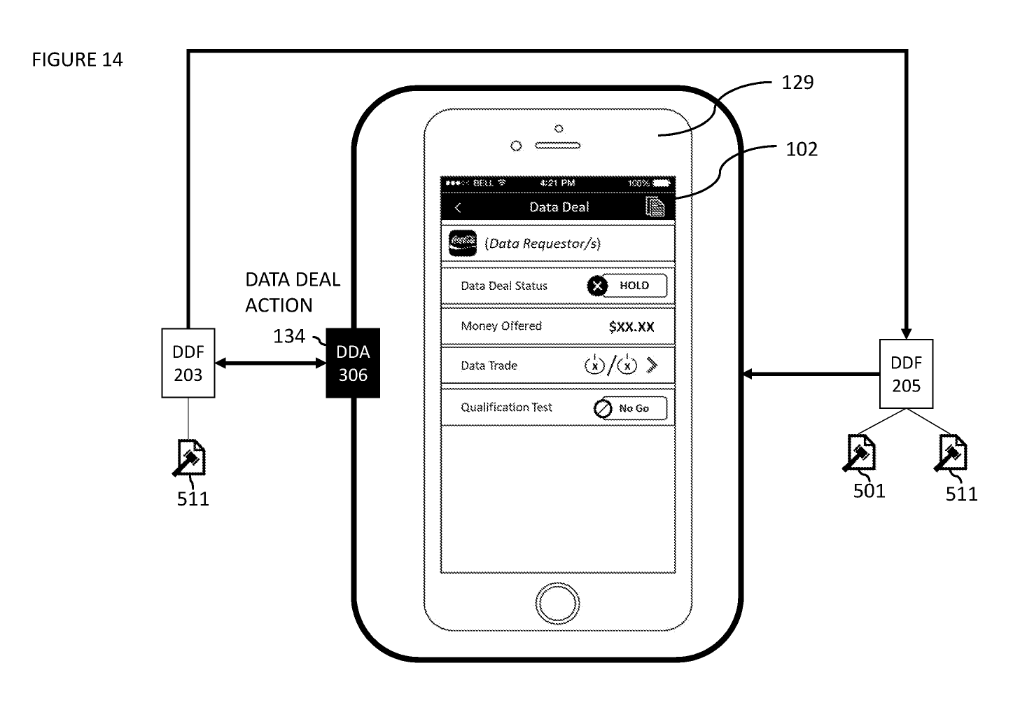

FIG. 14 represents a simplified and exemplary representation of workflow diagrams, mechanisms, and rules; other possible workflow diagrams can be used for describing a system implementation; wherein Data Supplier 107 will appreciate interacting with a Data Deal 102. The starting DDA 306 (a Data Deal Action 134) shows the Rule 511 applying due to DDF 203 (a Data Deal Flow 135). Once the DDA 306 reaches DDF 205, then Rule 501 and Rule 511 will apply. The rules are demonstrated on FIGS. 27 to 30.

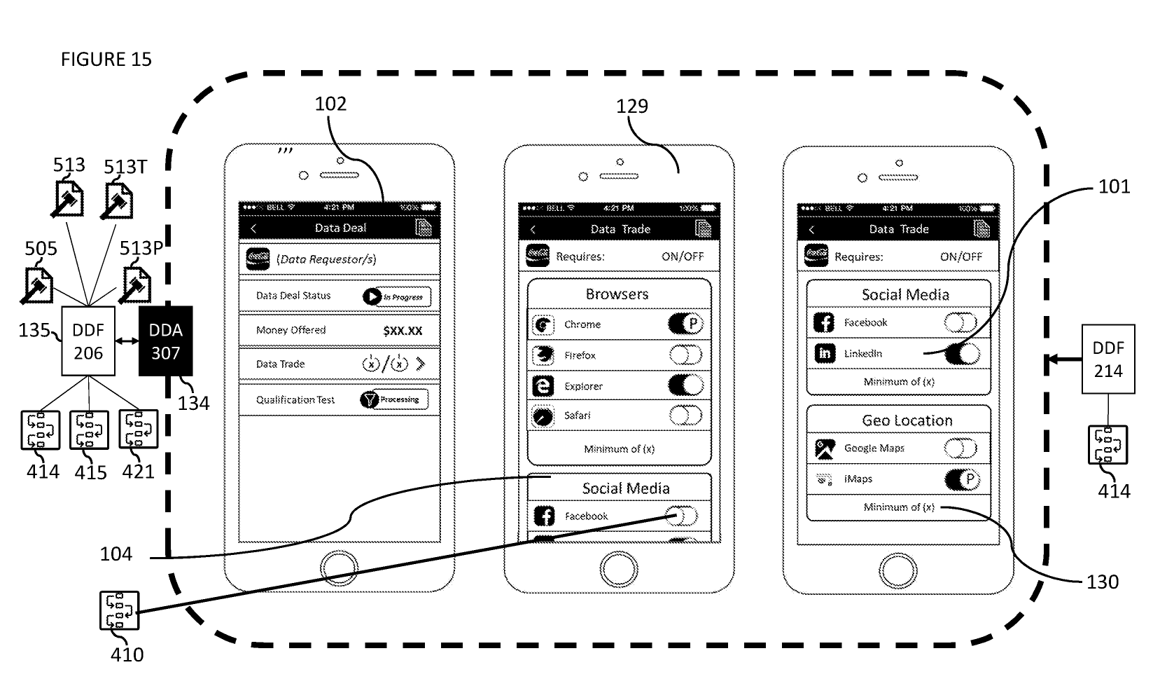

FIG. 15 represents a simplified and exemplary representation of workflow diagrams, mechanisms, and rules; other possible workflow diagrams can be used to describe a system implementation. A Data Supplier 107 will appreciate interacting with a Data Deal 102 and its elements like Data Sets 101, Data Blocks 104, and Data Block Minimum Requirement 130. The starting DDA 307 (a Data Deal Action 134) shows the Rule 505, Rule 513, Rule 513T, Rule 513P, Data Deal Filters Mechanisms 414, Data Source Validation Methods 415, Data Extraction Methods 421 were applying to the Data Supplier's 107 Data Deal 102 due to DDF 206 (a Data Deal Flow 135). Once DDF 214 loops any Data Supplier 107 that fails the Data Deal Filters Mechanisms 414. A Data Supplier 107 will remain on hold in the DDA 307 status until the DDA 307 passes and/or meets the requirements of the Rule 505, Rule 513, Rule 513T, Rule 513P, Data Deal Filters Mechanisms 414, Data Source Validation Methods 415, and Data Extraction Methods 421. In addition, DDF 214 placed any Data Deal 102 in a UE 129 into DDA 307 if the Data Deal Filters Mechanisms 414 determines to be the correct action based on the set criteria. In addition, at this DDF stage of the Data Deal 102, additional parts of the interface starts displaying, such as the Data Activation Methods 410. The rules are demonstrated on FIGS. 27 to 30.

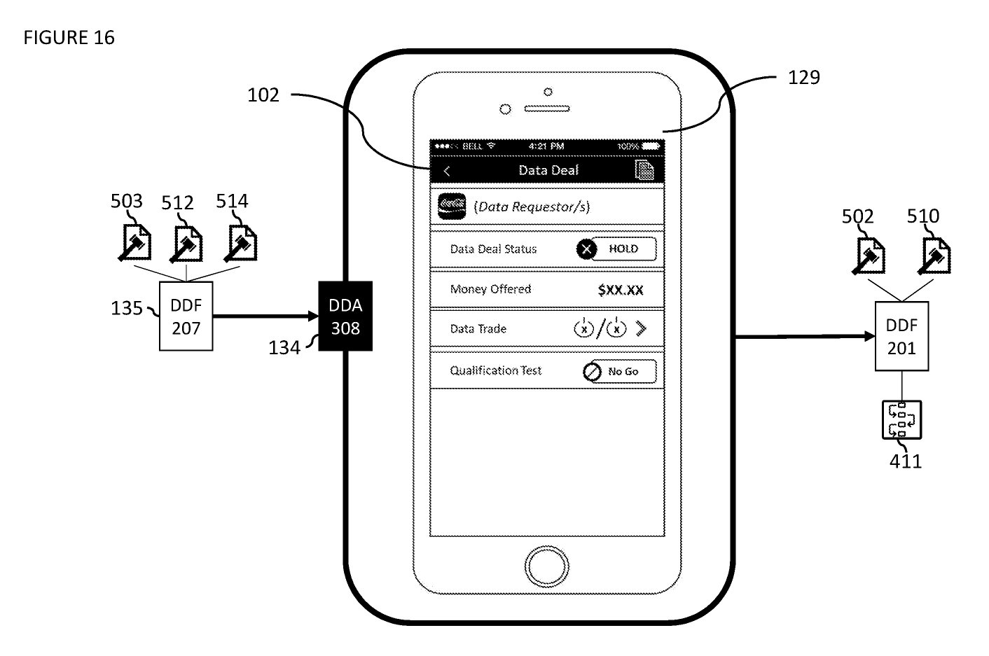

FIG. 16 represents a simplified and exemplary representation of workflow diagrams, mechanisms, and rules; other possible workflow diagrams can be used to describe a system implementation. A Data Supplier 107 skilled in using a smart device (UE 129) will appreciate interacting with a Data Deal 102. The starting DDA 308 (a Data Deal Action 134) shows the Rule 503, Rule 512, and Rule 514 applying due to DDF 207 (a Data Deal Flow 135). Once the DDA 308 reaches DDF 201, then Rule 502 and Rule 510 will apply along with Data Deal Creation & Release Methods 411.

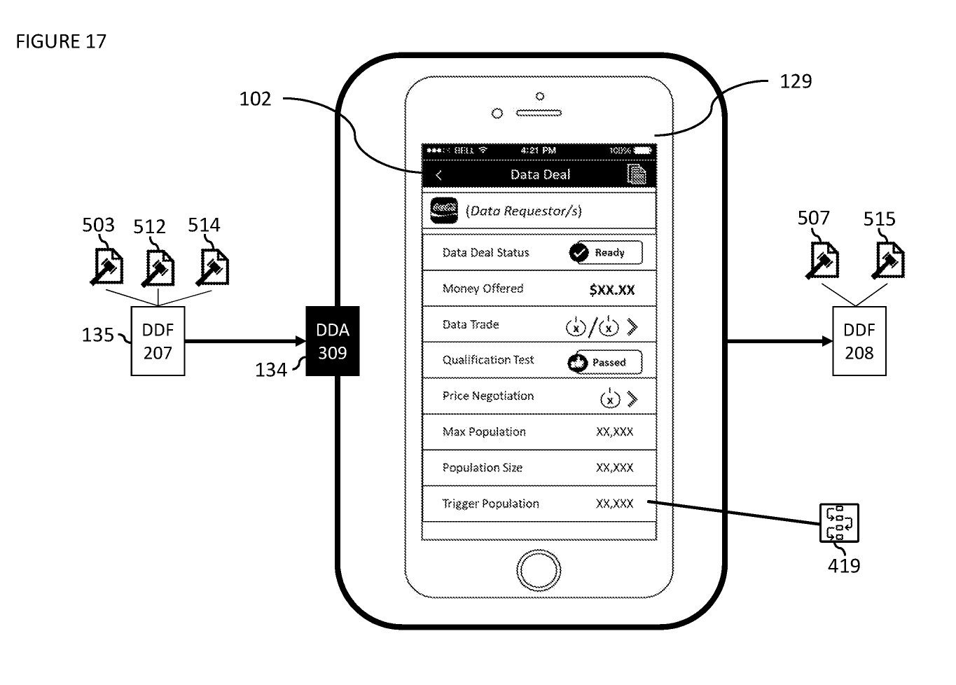

FIG. 17 represents a simplified and exemplary representation of workflow diagrams, mechanisms, and rules; other possible workflow diagrams can be used to describe a system implementation. A Data Supplier 107 skilled in using a smart device (an UE 129) will appreciate interacting with a Data Deal 102. The starting DDA 309 (a Data Deal Action 134) shows the Rule 503, Rule 512, and Rule 514 applying due to DDF 207. Once the DDA 308 reaches DDF 208 (a Data Deal Flow 135), then Rule 507 and Rule 515 will apply. In addition, at this DDF stage of the Data Deal 102, the Data Deal and the Data Deal Triggers Methods 419 interact. The rules are demonstrated on FIGS. 27 to 30.

FIG. 18 represents a simplified and exemplary representation of workflow diagrams, mechanisms, and rules; other possible workflow diagrams can be used for the invention describing a system implementation; wherein a Data Supplier 107 will appreciate interacting with a Data Deal 102 where the activated Data Sets 101. The starting DDA 310 (a Data Deal Action 134) shows the Rule 507 and Rule 515 applying due to DDF 208 (a Data Deal Flow 135). Once the DDA 310 reaches DDF 209, then Rule 508, Rule 516, Rule 517, and Data Negotiation Parameters Methods 418 will apply. In addition, at this stage of the Data Deal 102, Data Negotiation Parameters Methods 418 and Data Deal Triggers Methods 419 appear for the Data Supplier 107 to interact with the Data Deal 102. The rules are demonstrated on FIGS. 27 to 30.

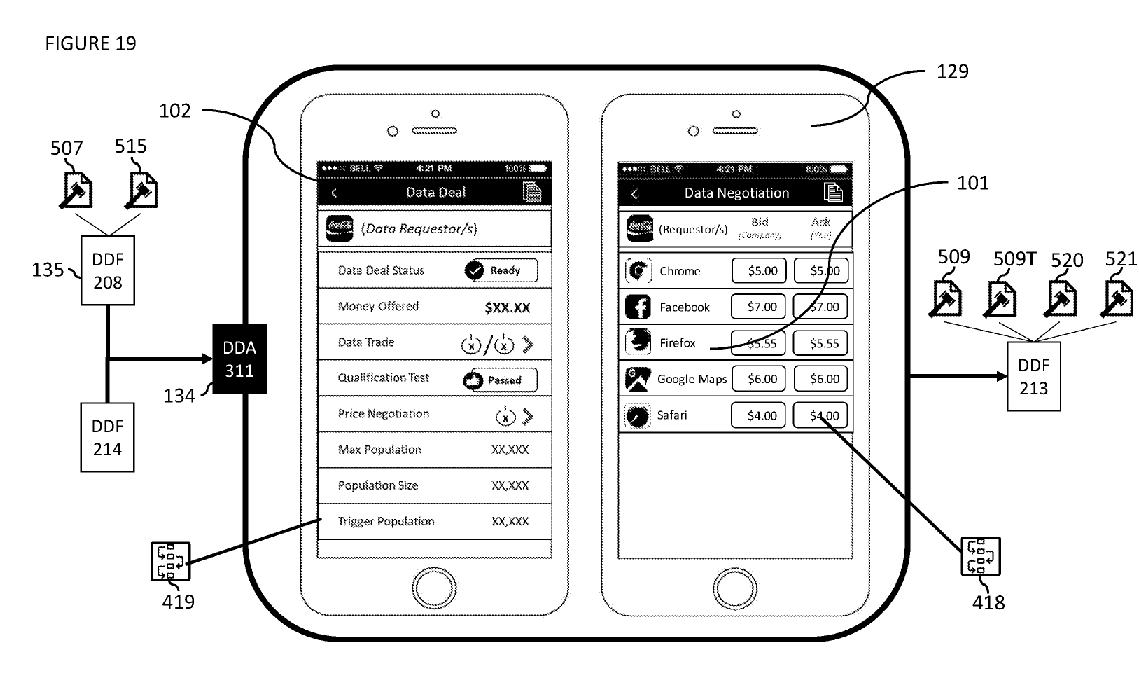

FIG. 19 represents a simplified and exemplary representation of workflow diagrams, mechanisms, and rules; other possible workflow diagrams can be used for the invention describing a system implementation; wherein a Data Supplier 107 will appreciate interacting and negotiating with the activated Data Sets 101 within this particular Data Deal 102. A Date Set 101 can be brokered at different prices for the very same Data Set 101 in different Data Deals 102. Data Requestors 106 bid for the Data Sets 101. Data Suppliers 107 can provide asks for their Data Sets 101. The bidding system is handled by the Data Negotiation Parameters Methods 418, which provides signals (ex. ‘red/yellow/green’ color schemas), prompts (ex. pop-ups), recommends (ex. average pricing index, which can be found in traditional stock markets), and, even, to auto-adjust price logic (ex. an widget with ‘index-style pricing auto follower’) to facilitate variable payments. The starting DDA 311 (a Data Deal Action 134) shows the Rule 507 and Rule 515 applying due to DDF 208 (a Data Deal Flow 135) or due to DDF 214. Once the DDA 311 reaches DDF 213, then Rule 509, Rule 509T, Rule 520, and Rule 521 will apply. In addition, at this DDF stage of the Data Deal 102, the Data Deal 102 and Data Negotiation Parameters Methods 418, and Data Deal Triggers Methods 419 interact. The rules are demonstrated on FIGS. 27 to 30.

FIG. 20 represents a simplified and exemplary representation of workflow diagrams, mechanisms, and rules; other possible workflow diagrams can be used for the invention describing a system implementation; wherein a Data Supplier 107 will appreciate interacting and negotiating with the activated Data Sets 101 within this particular Data Deal 102. The starting DDA 312 (a Data Deal Action 134) shows the applying due to DDF 212 (a Data Deal Flow 135). Until the DDA 312 passes and/or meets the requirements of DDF 212, then the Data Supplier 107 skilled using a smart device (UE 129) will remain on DDA 312. In addition, at this DDF Stage of the Data Deal 102, the Data Deal 102, Data Negotiation Parameters Methods 418, Data Deal and Triggers Methods 419 interact. The rules are demonstrated on FIGS. 27 to 30.

FIG. 21 represents a simplified and exemplary representation of workflow diagrams, mechanisms, and rules; other possible workflow diagrams can be used for the invention describing a system implementation; wherein a Data Supplier 107 skilled in using an iPhone smart device (an UE 129) will appreciate interacting with a Data Deal 102 where the activated Data Sets 101. The starting DDA 313 (a Data Deal Action 134) shows the applying due to DDF 215 (a Data Deal Flow 135). Until the DDA 313 passes and/or meets the requirements of DDF 215, then the Data Supplier 107 will remain on hold in DDA 313. In addition, at this DDF Stage of the Data Deal 102, elements and mechanisms, such as the Data Negotiation Parameters Methods 418, and Data Deal Triggers Methods 419, are displayed for the Data Supplier 107 interact with those mechanisms. The rules are demonstrated on FIGS. 27 to 30.

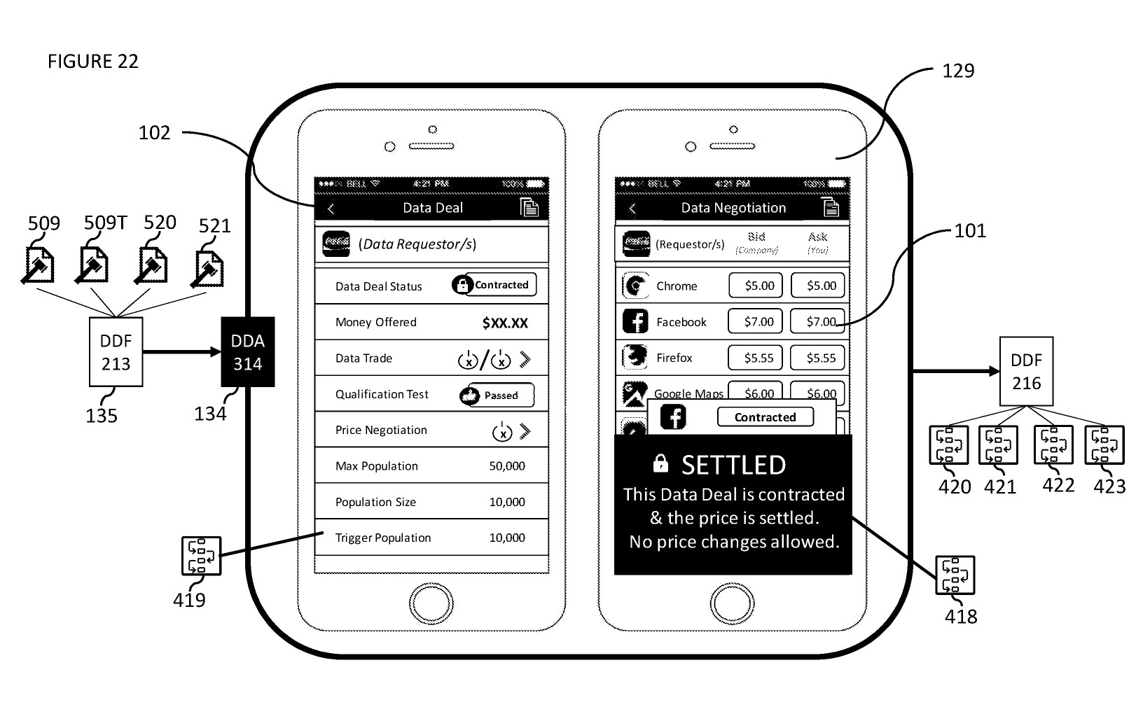

FIG. 22 represents a simplified and exemplary representation of workflow diagrams, mechanisms, and rules; other possible workflow diagrams can be used for describing a system implementation. wherein a Data Supplier 107 skilled in using a smart device (an UE 129) will appreciate interacting with a Data Deal 102 where the activated Data Sets 101. The starting DDA 314 (a Data Deal Action 134) shows the applying due to DDF 213 (a Data Deal Flow 135). The starting DDA 314 shows the Rule 509, Rule 509T, Rule 520, and Rule 521 applying due to DDF 213. Once the DDA 314 reaches DDF 216, then Payment Schedule Methods 420, Data Extraction Methods 421, Data Transfer Methods 422, and Data Treatment Methods 423 be will apply. In addition, at this DDF stage of the Data Deal 102, the elements and mechanisms interactions with the Data Supplier 107, such as the Data Negotiation Parameters Methods 418, and the Data Deal Triggers Methods 419. The rules are demonstrated on FIGS. 27 to 30.

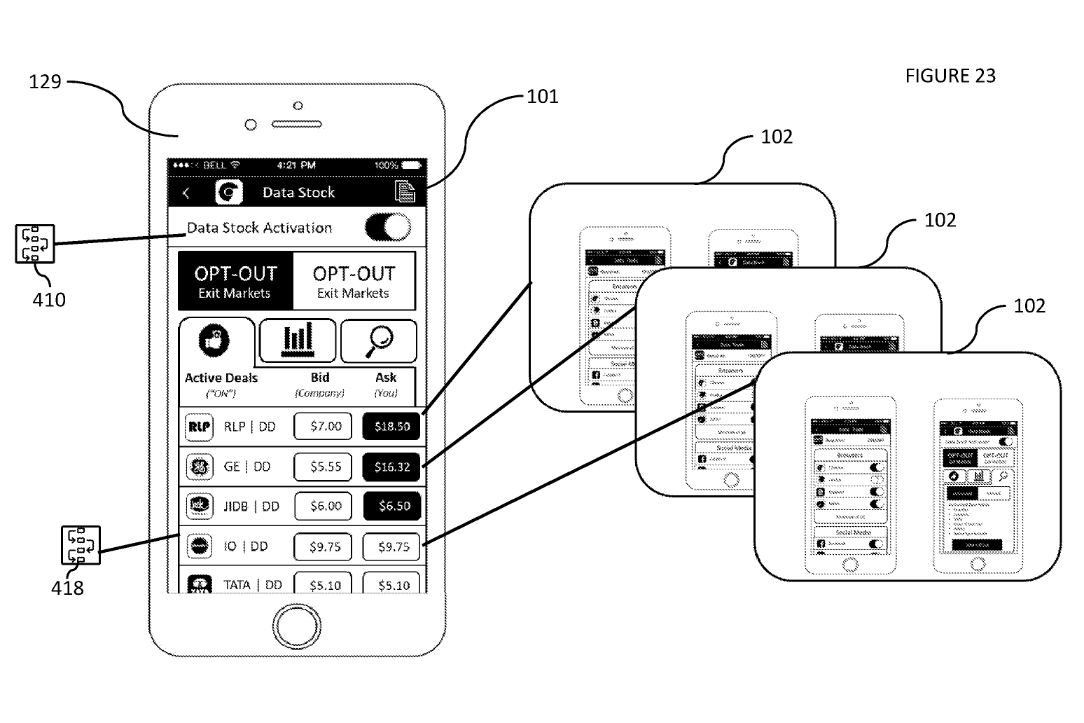

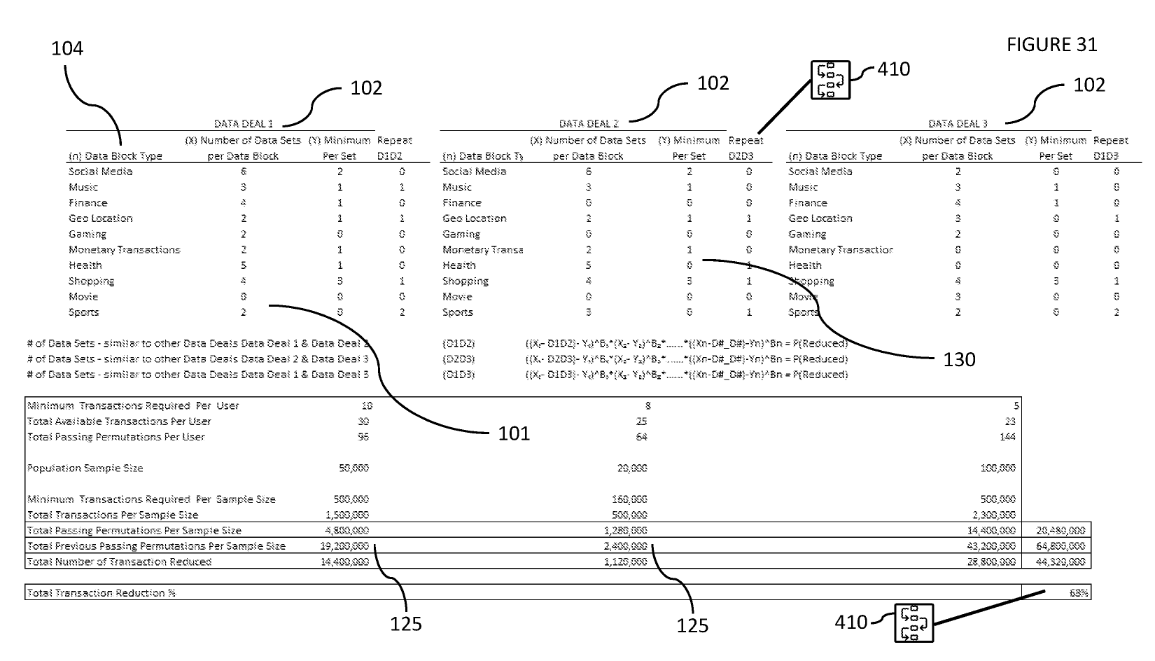

FIG. 23 represents a simplified and exemplary representation of workflow diagrams, mechanisms, and rules; other possible workflow diagrams can be used for the invention describing a system implementation; wherein a Data Supplier 107 skilled in using a smart device (an UE 129) will appreciate interacting with several Data Deals 102 from the perspective of an activated Data Set 101. Note that an activated Data Set 101 may automatically meet the criteria of Data Set 101 requirements for all current and future Data Deals 102 that require that same selected Data Sets 101. This FIG. 31 shows how these interactions reduced data transactions. From this mode, the Data Sets 101 displays the Data Activation Methods 410 and Data Negotiation Parameters Methods 418 in action. The rules are demonstrated on FIGS. 27 to 30.

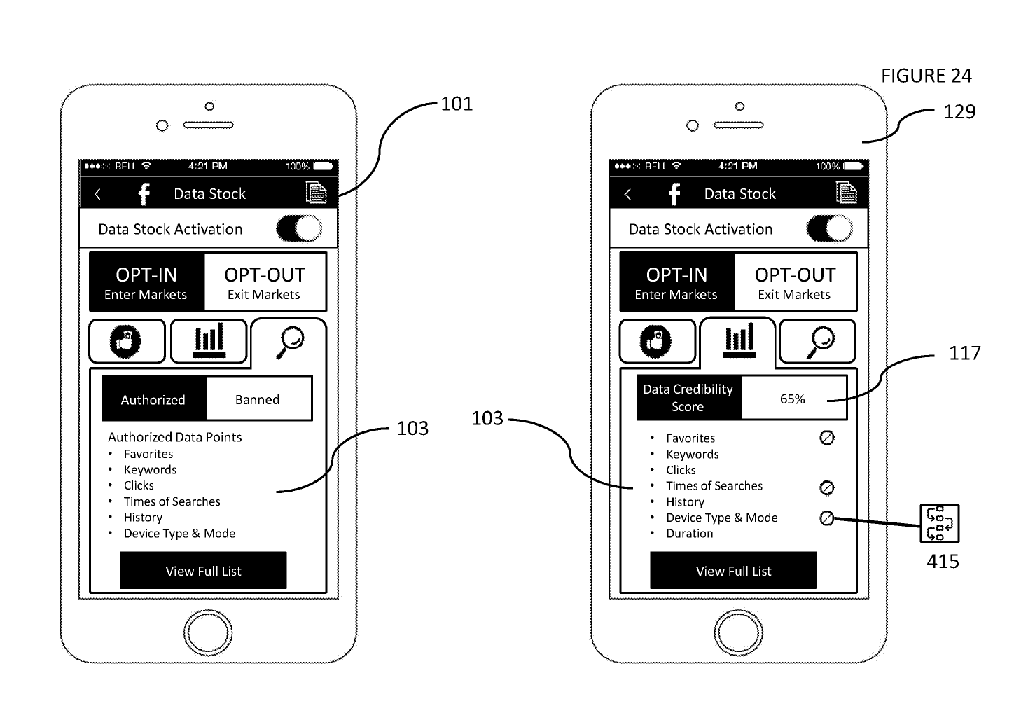

FIG. 24 represents a simplified possible schematic embodiment of the invention describing a system implementation wherein User Equipment (UE) 129 may belong to a Data Requestor 106 (subsidized), contracted (via Internet Provider or Telecom Company), shared between Data Suppliers 107, and/or solely owned by user linked to Data Supplier 107 (e.g., an individual). UE 129 may have installed the Data Deal Portal 112 with an embodiment of the invention. The Data Suppliers 107 with an embodiment of the invention in an UE 129 can enter the Data Deal Portal 112 via a remote portal browser like Chrome, Safari as examples. The Data Supplier 107 skilled in using a smart device (an UE 129) will appreciate that multi-dimensional Data Sets 101 organized into data groupings of Data Points 103 to Data Sets 101. In this UE 129, the user can see the Data Credibility Score 117 for that Data Set 101 based on the Data Points 103 matches and mismatches set by Data Source Validation Methods 415.

FIG. 25 represents a simplified possible mathematical schematic embodiment of the invention's arithmetic of a system implementation; in this example, the Data Deal 102 has 10 distinct Data Blocks 104 requesting up to 33 unique Data Sets 101 and 7 Data Blocks 104 with unique Data Block Minimum Requirements 130. These Multi-Dimensional Multi-Source Data Requests 125 create a large permutations of data transactions.

FIG. 26 represents a simplified possible mathematical schematic embodiment of the invention's arithmetic of a system implementation; in this example, there are three Data Deals 102 with multiple Data Blocks 104 requesting many Data Sets 101 and several Data Blocks 104 have a Data Block Minimum Requirements 130. Several Multi-Dimensional Multi-Source Data Requests 125 create even larger amount of permutations of data transactions.

FIG. 27 represents a simplified and exemplary representation of legend for rules in the workflow diagrams; other possible workflow diagrams can be used for the invention describing a system implementation; in this case, the Rules 501, 502, 503, 504, 505, 506, 507, and 508 that provide criteria for DDFs (Data Deal Flows 135) demonstrated on FIG. 7 and FIGS. 9 to 22. The use of rules for decision points and data control points ensure that the Data Supplier 107 and the Data Requestor 106.

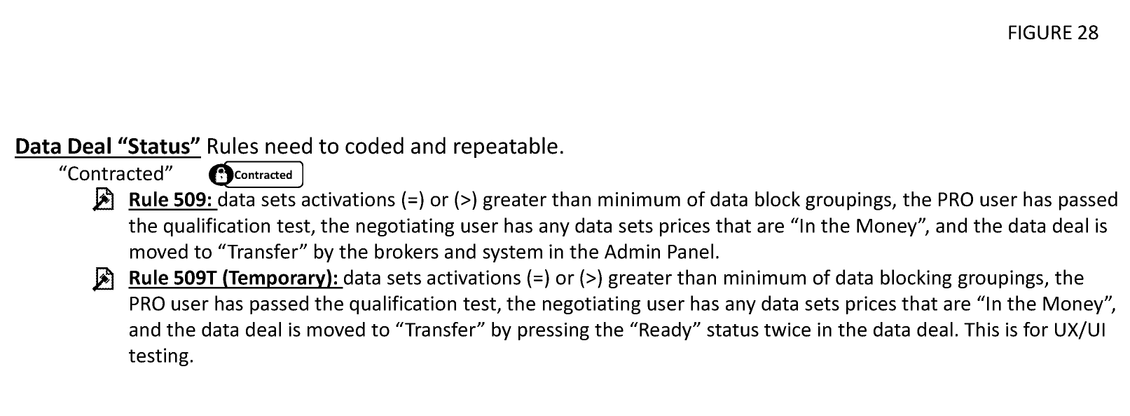

FIG. 28 represents a simplified and exemplary representation of legend for rules in the workflow diagrams; other possible workflow diagrams can be used describing a system implementation. The rules 509 and 509T that provide criteria for DDFs (Data Deal Flows 135) demonstrated on FIG. 7 and FIGS. 9 to 22 as an implementation.

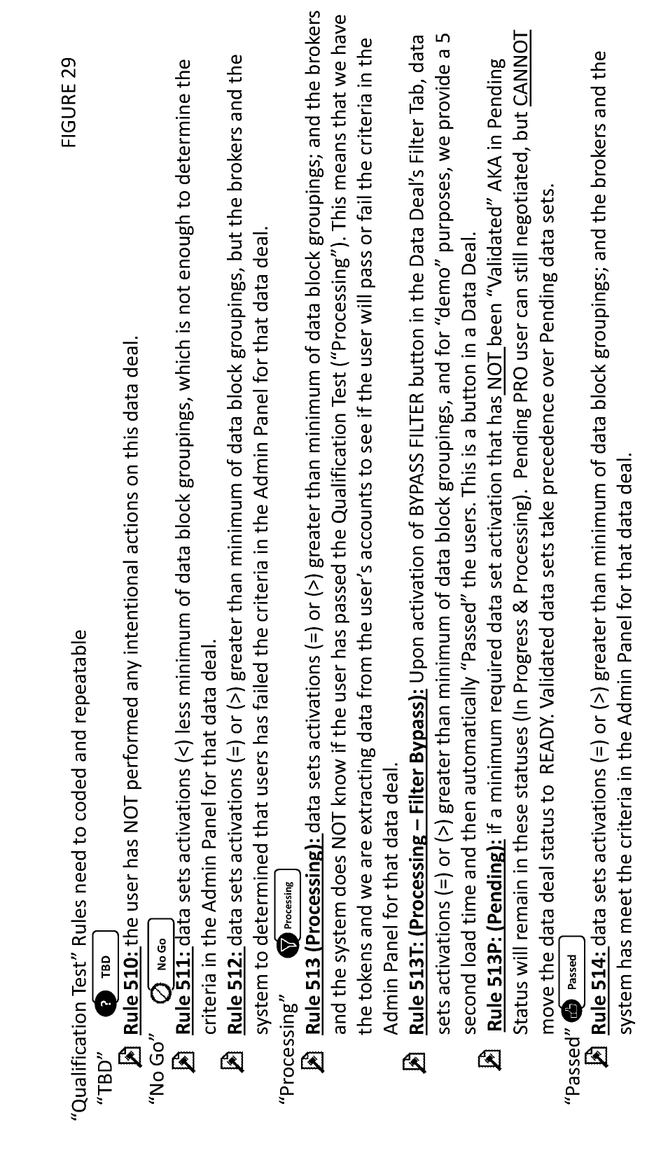

FIG. 29 represents a simplified and exemplary representation of legend for rules in the workflow diagrams; other possible workflow diagrams can be used for describing a system implementation; in this case, the Rules 510, 511, 512, 513, 513T, and 514 that provide criteria DDFs (Data Deal Flows 135) demonstrated on FIG. 7 and FIGS. 9 to 22 as an implementation.

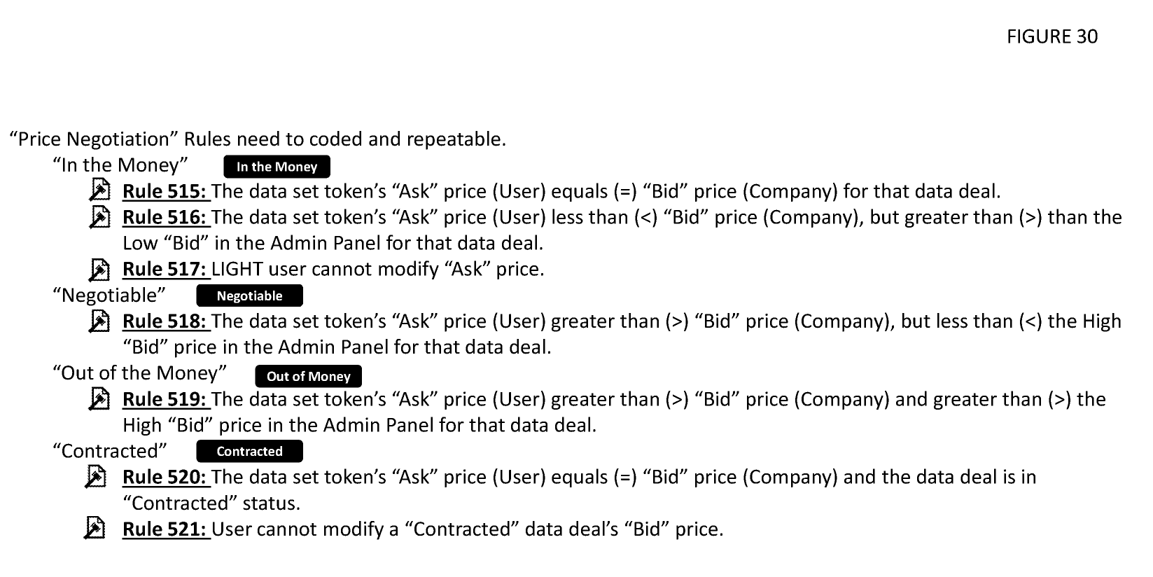

FIG. 30 represents a simplified and exemplary representation of legend for rules in the workflow diagrams; other possible workflow diagrams can be used for describing a system implementation. The Rules 515, 516, 517, 518, 519, 520, and 521 that provide criteria for DDFs (Data Deal Flows 135) demonstrated on FIG. 7 and FIGS. 9 to 22 as an implementation.

FIG. 31 represents a simplified possible schematic embodiment of the invention's arithmetic of a system implementation. In this mathematical example, there are 3 Data Deals 102. Each Data Deal 102 had multiple Data Sets 101 in unique Data Blocks 104 requesting many Data Sets 101. Some of the same Data Sets 101 may be requested by different Data Deals 102 and the unique Data Blocks 104 have different Data Block Minimum Requirements 130 as set by the Data Requester 107. As Data Sets 101, Data Blocks 104, and Data Suppliers 107 populations increase in requests, the Multi-Dimensional Multi-Source Data Requests 125 are produced a large data transactions amount of permutations. This case, for a Data Supplier 107 of 170,000 users in 3 Data Deals 102 can use of the Data Activation Methods 410 reduce the permutation of transactions by 68% of 64,800,000.

FIG. 32 represents a simplified possible schematic embodiment of the invention describing a system implementation using e-wearable technology wherein Data Suppliers 107 skilled in using an iPhone smart device (UE 129) and AppleWatches (UE 129) will appreciate how the Proximity Account Switching 700 feature can manage distinct, separate, and tag data production records of any Data Suppliers 107 wearing the AppleWatches (UE 129) upon using the same device and associated account. In this case, the device holder nearest e-wearable (a secondary UE 129) to the Primary UE 129 will be sync and validated as the Data Supplier 107 for the device (the primary UE 129). Bluetooth technology can facilitate the synchronization process between UEs 129 and between Data Suppliers 107.

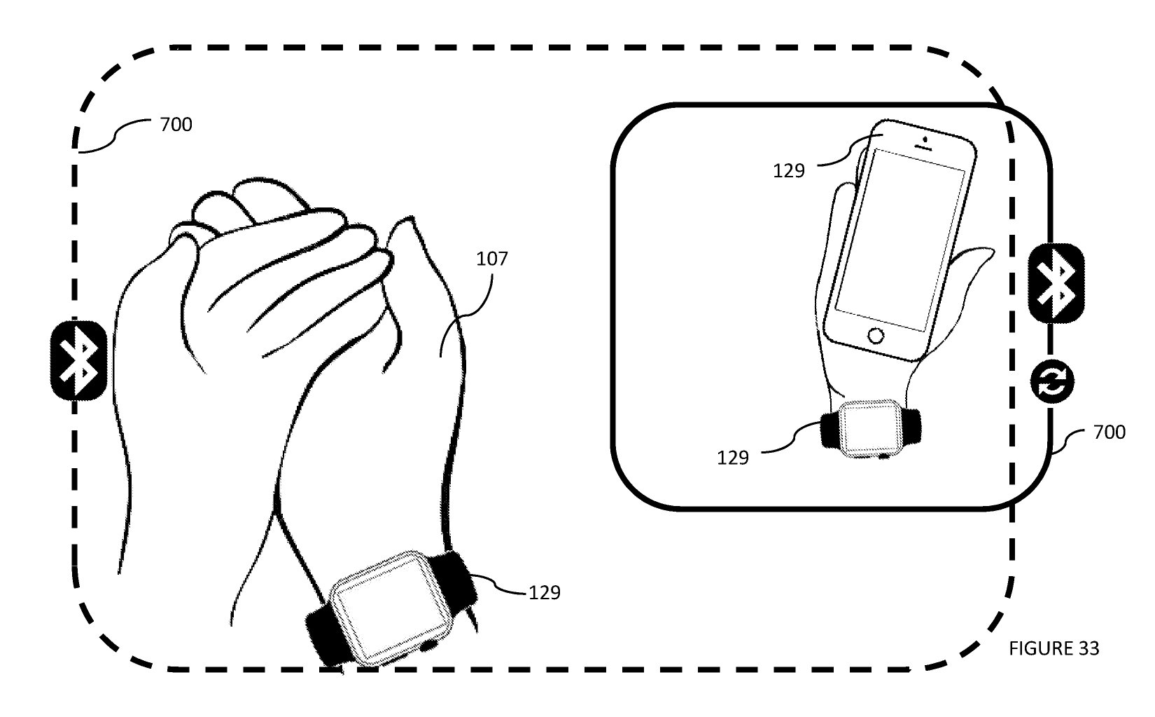

FIG. 33 represents a simplified possible schematic embodiment of the invention describing a system implementation using e-wearable technology. Data Suppliers 107 skilled in using an iPhone smart device (UE 129) and AppleWatches (UE 129) will appreciate that Proximity Account Switching 700 can manage distinct and separate data production records of the Data Suppliers' 107 wearing the AppleWatches (UE 129) upon using the same device and associated proximity. This case is the inverse. In this UE 129 switched hands due to any reason (ex. changing music in the car), the device holder nearest e-wearable (a secondary UE) to the Primary UE 129 will be sync and validated as the Data Supplier 107 for the device (the primary UE 129) and associate the activity (ex. play the song ‘Chariots of Fire’ by Yanni in the iTunes App) was selected and the recorded to the synced account. Bluetooth technology can facilitate the synchronization process between UEs 129 and between Data Suppliers 107.

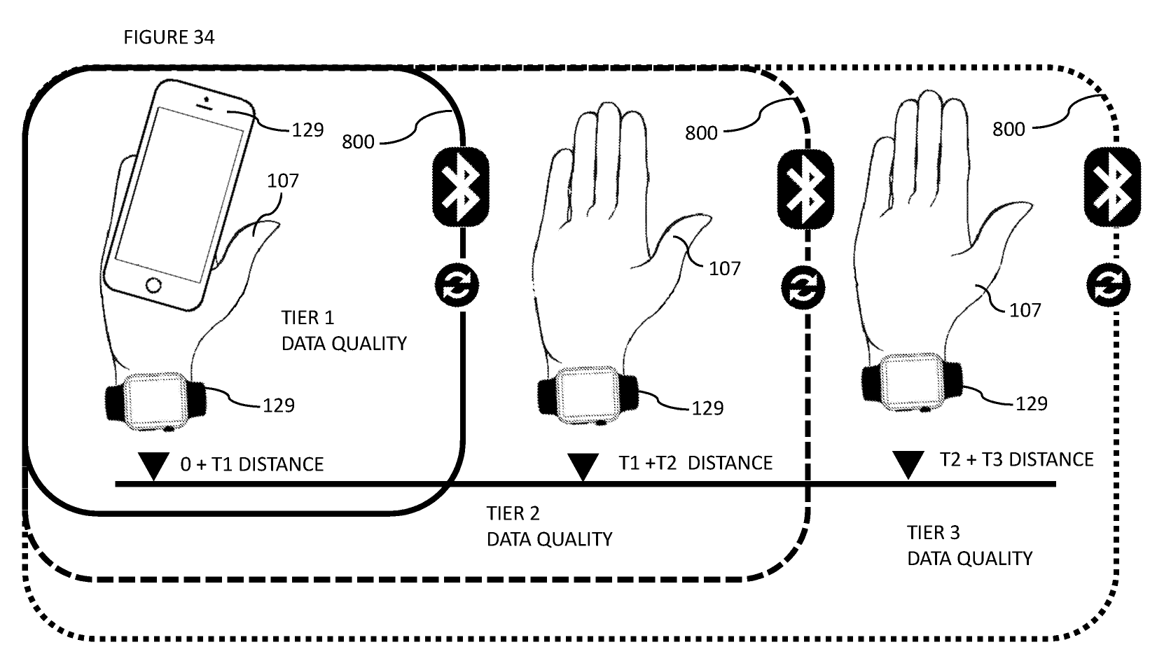

FIG. 34 represents a simplified possible schematic embodiment of the invention describing a system implementation using e-wearable technology. Data Suppliers 107 skilled in using an iPhone smart device (UE 129) and AppleWatches (UE 129) will appreciate the Proximity Data Tier Grading 800 feature. This feature improves the data quality of the recorded, metatagged, and ranked data productions within a UE 129 based on the proximity of the Data Supplier, the Data Supplier's 107 iPhone (UE 129) producing the data, and an iWatch (a secondary UE 129) to constantly triangulate the Data Supplier's 107 location by constantly identifying two known GPS locations, to the unknown point, the Data Supplier. The ranking and grading of data tier can be multi-tier and/or multi-geo fences.

FIG. 35 represents a simplified and exemplary representation of workflow interface, mechanisms, and rules; other possible workflow diagrams can be used for describing a system implementation. A Data Deal Broker 108 account and skilled in using a smart device (an UE 129) will appreciate a Data Deal Portal 112 that quickly interacts with the Data Requestors 106, Data Suppliers 107, Data Deals 102, rules, and mechanisms. In the process of creating a Data Deal 102, the Data Deal Broker/s 108 can add, modify, and/or delete any Data Deal 102 and various elements, such as the Data Sets 101, data filters in the Data Deal Filter Mechanisms 414, the name of the Data Deal 102, account information that functions with the Payment Schedule Mechanism 420, the bids for different Data Sets 101 within the Negotiation Parameters Mechanism 418, the Setup of the Data Lakes 130, and more. The Data Deal 102 can be auto populated by a Data Deal Quote 113. The Data Brokers 108 can release or retract any Data Deal 102 from Data Markets 131 using the Data Deal Creation & Release Methods 411.

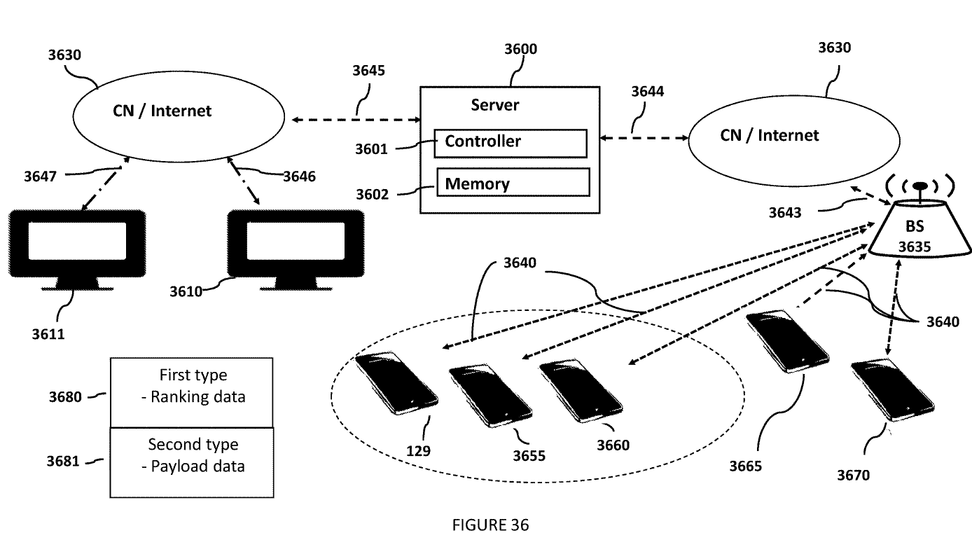

FIG. 36 represents a simplified and exemplary representation of a computer system, method and apparatus to optimize the gathering of information from Data Suppliers 107 and, in general, the operation of Server 3600. Server 3600 can be comprising the memory and the processing capabilities needed to implement the system and method described generally with reference to FIG. 1 and others. In one implementation, Server 3600 contains Memory 3602 and Controller 3601. Memory 3602 contains one or more algorithms in charge of administering the collection of data and information from User Equipment (UE) 129, User Equipment 3655, User Equipment 3660, User Equipment 3665 and User Equipment 3670. User equipment should be considered not only smart phones (as most common nowadays) but also any current or future personal equipment (including wearable and/or fixed) that can be associated with a Data Supplier's 107 account. A Controller 3601 is in charge of executing said algorithms and directing communications via Link 3645 and Link 3644 with User Equipment and other equipment. Links 3647, 3646, 3643, 3645, 3644 and 3640 should be considered any means, radio, fiber, or cable, capable of transporting information though the Core Network/Internet 3630. CN/Internet 3630 is any hardware capable of regenerating and redirecting signals and information via and toward any internet or telecommunication endpoint.

In certain implementations, Data Suppliers 107 will allow the collection of First Type—Ranking Data 3680 that will be organized in datagrams stored in memory 3602. First Type—Ranking Data 3680 in certain implementations, are data collected from Data Suppliers 107 via UE 129, 3655, 3660, 3665 and 3670 and are used to create a plurality of hierarchies among Data Suppliers 107 that are used to rank them as to their usefulness of their Second Type Payload Data 3681 to predetermined Data Deals. Second Type Payload Data can be collected and organized in datagrams stored in memory 3602. First Type—Ranking Data 3680 may determine an order in which Data Suppliers 107 associated with UE 129, 3655, 3660, 3665 and 3670 are asked manually or automatically to release their Second Type—Payload Data 3680 and can also determine the price that, e.g., Data Suppliers (or users of UEs) are offered. The release of Second Type—Payload Data 3680 can be automatized according to settings by users. The person skilled in the art will know that not all the Data Suppliers 107 need to be paid the same compensation as presented in Data Negotiation Parameters Methods 418.

The compensation paid to Data Suppliers can vary. As non-limiting examples, it can consist in money, discounts, products, services and/or acquired privileges.

Creating a dynamic hierarchy among Data Suppliers 107 that is created via First Type—Ranking Data 3680 when a predetermined Data Deal is created requiring the collection of Second Type—Payload Data 3680 will enable the hierarchical and prioritized probing of Data Suppliers 107 via their UE 129, 3655, 3660, 3665 and 3670.

The person skilled in the art will understand that not all Data Suppliers 107 associated to their respective UE 129, 3655, 3660, 3665 and 3670 need to be asked to release their Payload Data. When a quota of Data Suppliers with a higher ranking as to a specific Data Deal have agreed to release their respective Second Type-Payload Data 3681 and a predetermined statistical sample has been reached (which can be a combination of number of accepting Data Suppliers weighted according to a parameter representing the usefulness of their payload data) other Data Suppliers will not be asked.

An optimization algorithm may ensure that the highest quality of Second Type—Payload Data 3681 is collected combined with the highest efficiency of the system in order to reduce Multi-Dimensional Multi-Source Data Requests 125.

This will save signaling, computations and will improve the operation of Server 100 since the hierarchical approach will minimize the useless pinging of low tier Data Suppliers 107 once higher tier Data Suppliers 107 agree to release their Payload data.

Here follows one of many possible examples of the usage of first Type—Ranking Data 3680 in relation to a Data Deal for which a Second Type payload data can be assembled and requested from users.

Data Suppliers 107 owners of UE 129, 3655, 3660, 3665 and 3670 can be asked to provide row data of their GPS locations at interval times. Let say, that a Data Suppliers 107 is detected to be at time T1 in city A and at time T2 on the runway of an airport of city B since the GPS location can be reported as soon as a UE is turned ON.

Usually a user turns ON a UE as soon as a plane touches the runway of the new destination city. By querying a database of flight schedules, actual departures and actual arrival times and/or arrival gates it is possible to pinpoint which flight and airline a Data Supplier 107 has been flying. Let us say that Data Requestors 106 are interested knowing which services and products a Data Suppliers 107 with no attachment to a particular airline (frequent flier membership) pays for. By using this system, and in particular First type—Ranking data, an algorithm running on Server 3600 can determine those users whose Second type payload data has the higher value for this particular Data Deal 102.

Accordingly, Data Suppliers 107 associated to UE 129, 3655, 3660, 3665 and 3670 can be pinged in sequence and hierarchically according to how their First Type data fit the profile required. Once the system has achieved the needed statistical sample, the pinging will stop leaving less significant Data Suppliers 107 tiers out of the sampling.

In another implementation, the compensation can be modulated according to different First type tiers data according to a variety of schemes so that the release of valuable payload data is facilitated for higher value Data Suppliers 107.

The person skilled in the art will understand that there are a myriad of sensors and/or data that can be used to build First type ranking data profiles. These profiles are built over time and perhaps can be assembled once a predetermined query for Payload data has been identified per Data Supplier 107. Once the payload is known, inferences can be drawn between First Type and Second Type data such that First type data (which are usually low confidentiality data) can be assembled to rank those Data Suppliers 107 for which we infer high value payload data.

By using, UE 129 microphones, Data Deal Brokers 108 and Data Requestors 106 can track sample noise around a Data Supplier 107. With this feature, Data Deal Brokers 108 and Data Requestors 106 request a one or more respective Data Sets 101 (ex. Siri App, any News App, Shazam Music App, Sound Hound Music App, etc. . . . ) in order to understand the Data Points 103 of which News provider a Data Supplier 107 is most frequently listening to (ex. Frequency, Content, History, and more). This data can Data Deal Brokers 108 and Data Requestors 106 help indication about Data Supplier's 107 local ambient, favorite music, political inclination, and more.

Many examples of First type data collection can be provided though literature. For example the papers 1) “Activity recognition with smartphone sensors” by X Su, H Tong, P Ji—Tsinghua Science and Technology, 2014—ieeexplore.ieee.org, 2) “By train or by car? Detecting the user's motion type through smartphone sensors data” by L Bedogni, M Di Felice, L Bononi—Wireless Days (WD), 2012—ieeexplore.ieee.org, 3) Towards physical activity recognition using smartphone sensors by M Shoaib, H Scholten, 2013—ieeexplore.ieee.org, 4) Activity recognition using hierarchical hidden markov models on a smartphone with 3D accelerometer by Y S Lee, S B Cho— . . . Conference on Hybrid Artificial Intelligence Systems, 2011—Springer furnish several examples of First Type—Ranking data 3680 provide useful examples. All of these papers are incorporated by reference in their entirety.

In certain implementations, Data Suppliers' 107 accounts (e.g. UE 129, 3655, 3660, 3665 and 3670) can be ranked hierarchically according to First type ranking data as to the usefulness of their Payload data to a predetermined Data Deal 102.

The hierarchy can be tested according to several methodologies to include the methods mentioned in Data Deal Filters Mechanism 414, such as LIFO, FIFO, prioritize by High Data Credibility Score 117, by lowest price bidder, basic sorting, and/or more.

For example, Data Deal Brokers 108 and Data Requestors 106 want to pinpoint a class of Data Suppliers' 107 characterized by wealthy class income. Social studies may suggest that wealthy individuals tend to surround themselves with equally wealthy individuals in certain time periods during the day and that other interactions may be affected by seasonality. Social studies may also suggest that university professors surround themselves with other university professors. Many other examples are possible.

In one embodiment of the invention a cluster of users such as UE 129, 3655, 3660 can be tested for proximity and statistical tendency to aggregation such that we enhance the probabilities that we can eliminate any possible outlier. Statistical tendency to aggregation can be tested via location modules contained in a UE 129.

The aggregation can be detected by establishing proximity rules, for example a weighted combination of a distance data and time data spent by users in mutual proximity.

In another embodiment, the aggregation between users can be tested by social network proximities (e.g. first or second-degree contacts).

In one implementation, Computer equipment 3610 can be used as an input/output apparatus to provide associations between First type—Ranking data and Second type—Payload data.

In one implementation, Computer equipment 3611 can be used as an input/output apparatus to provide requests for Second type—Payload data.

Embodiments of the present invention may be implemented in software, hardware, application logic or a combination of software, hardware and application logic. The software, application logic and/or hardware may reside on a Data Supplier's 107 UE 129 (ex. iPhone), segregated servers from the Data Lakes 132, in the Data Lakes 132 environments, in the hosted environments (ex. AWS, Azure, Shopify), in the Data Requestor's 106 environments (ex. modify server landing zones to facilitate the Data Transfer Mechanisms 422), and/or distributed in a P2P network with or without block chain technology enhancements. If desired, part of the software, application logic and/or hardware may reside on a Data Supplier's 107 UE 129, part of the application logic and/or hardware may reside on segregated servers from the Data Lakes 132, part of the application logic and/or hardware may reside in the Data Lakes 132 environments, part of the application logic and/or hardware may reside in the Data Requestor's 106 environments, part of the software, application logic and/or hardware may reside on hosted environments, and part of the software, application logic and/or hardware may reside on distributed in a P2P network with or without block chain technology enhancements. Using P2P network for storage and distribution, Data Suppliers 107 gain more control over their Data Sets 101, since their Data Sets 101 are stored in the device. Simultaneously, P2P network reduces the Data Deal Brokers 108 need to purchase additional servers to store un-brokered Data Sets 101 that are not producing monetary gain. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with few examples of a computer described and depicted in FIGS. 1B, 2, 4, 9, 10, 11, 12, 13, 14, 15, 16, 17, 18, 19, 20, 21, 22, 23, 24, 32, 33, and 35. A computer-readable medium may comprise a computer-readable storage medium that may be any media or means that can contain or store the instructions for use by or in connection with an instruction execution system, apparatus, or device, such as a computer.

There are two main kinds of semiconductor memory, volatile and non-volatile. Examples of non-volatile memory are flash memory (used as secondary memory) and ROM, PROM, EPROM and EEPROM memory (used for storing firmware such as BIOS). Examples of volatile memory are primary storage, which is typically dynamic random-access memory (DRAM), and fast CPU cache memory, which is typically static random-access memory (SRAM) that is fast but energy-consuming, offering lower memory areal density than DRAM.

Non-volatile memory is computer memory that can retain the stored information even when not powered. Examples of non-volatile memory include read-only memory (see ROM), flash memory, most types of magnetic computer storage devices (e.g. hard disk drives, floppy disks and magnetic tape), optical discs, and early computer storage methods such as paper tape and punched cards. Non-volatile memory technologies may include FeRAM, CBRAM, PRAM, STT-RAM, SONOS, RRAM, racetrack memory, NRAM, 3D XPoint, and millipede memory.

The present invention consisting in a method, system and apparatus to manage focus groups is enabled by computer instructions stored on non-volatile memories.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

A plurality shall mean one or more.

It is also noted herein that while the above describes example embodiments of the invention, these descriptions should not be viewed in a limiting sense. There are several variations and modifications which may be made without departing from the scope of the present invention as defined in the appended claims.

What is claimed is:

1. Method for managing focus groups comprising:
collecting a first set of data from user equipment associated with a plurality of users;
establishing a hierarchy between said plurality of users in relation to a predetermined data deal by using said first set of data;
aggregating a plurality of multi-dimensional and multi-source requests for a second set of data from at least a subset of said plurality of users into a singular data deal mechanism;
reducing said plurality of multi-dimensional multi-source data requests by re-allocating activated data sets shared by similar data deal mechanisms;
using data points to compare the integrity of said second set of data with a predefined threshold, wherein:
a) said predefined threshold is determined by parameters selected from the group consisting of: a geographic parameter, a demographic parameter, a behavioral parameter and combinations thereof; and
b) said hierarchy determines the final composition of said subset of said plurality of users, such that requests to lower tier users' equipment for said second sets of data is conditional to higher tiers users' acceptance.

2. The method of claim 1, wherein said integrity is enhanced by investigating parameters selected form the group consisting of: name discrepancies, geo-location discrepancies, activities discrepancies, usage of aliases, simultaneous usage of the same account, simultaneous usage of multiple devices, simultaneous usage of the same device by multiple users, and combinations thereof.

3. The method of claim 2, wherein said data collections have installations of quality controls selected from the group consisting of: e-wearable technology validations via proximity data tier grading to label data production based on user proximity, proximity account switching between users sharing a device, and combinations thereof.

4. The method of claim 2, further comprising triggering a compensation functionality for said at least said subset of said plurality of users upon reception of said second set of data.

5. The method of claim 4, wherein said compensation functionality for said at least said subset of said plurality of users is dependant form data selected from the group consisting of: rights allocation management data, usage data, rent data, lease data and combinations thereof.

6. The method of claim 1, wherein said subset of said plurality of users is tested for location based aggregation.

7. The method of claim 1, further comprising providing a bid and ask management mechanism through a data-brokering platform.

8. At least one non-transitory computer-readable medium having a set of instructions for controlling at least one general-purpose digital computer in performing desired functions comprising:
a set of instructions formed into each of a plurality of modules, each modules comprising:
a process for collecting a first set of data from user equipment associated with a plurality of users;
a process for establishing a hierarchy between said plurality of users in relation to a predetermined data deal by using said first set of data;
a process for aggregating a plurality of multi-dimensional and multi-source requests for a second set of data from at least a subset of said plurality of users into a singular data deal mechanism;
a process for reducing said plurality of multi-dimensional multi-source data requests by re-allocating activated data sets shared by similar data deal mechanisms;
a process for using data points to compare the integrity of said second set of data with a predefined threshold, wherein:
c) said predefined threshold is determined by parameters selected from the group consisting of: a geographic parameter, a demographic parameter, a behavioral parameter and combinations thereof; and
d) said hierarchy determines the final composition of said subset of said plurality of users, such that requests to lower tier users' equipment for said second sets of data is conditional to higher tiers users' acceptance.

9. The non-transitory computer-readable medium of claim 8, wherein said integrity is enhanced by investigating parameters selected form the group consisting of: name discrepancies, geo-location discrepancies, activities discrepancies, usage of aliases, simultaneous usage of the same account, simultaneous usage of multiple devices, simultaneous usage of the same device by multiple users, and combinations thereof.

10. The non-transitory computer-readable medium of claim 9, wherein said data collections have installations of quality controls selected from the group consisting of: e-wearable technology validations via proximity data tier grading to label data production based on user proximity, proximity account switching between users sharing a device, and combinations thereof.

11. The non-transitory computer-readable medium of claim 9 further comprising a process for triggering a compensation functionality for said at least said subset of said plurality of users upon reception of said second set of data.

12. The non-transitory computer-readable medium of claim 11, wherein said compensation functionality for said at least said subset of said plurality of users is dependant form data selected from the group consisting of: rights allocation management data, usage data, rent data, lease data and combinations thereof.

13. The non-transitory computer-readable medium of claim 8, wherein said subset of said plurality of users is tested for location based aggregation.

14. The non-transitory computer-readable medium of claim 8 further comprising a process for providing a bid and ask management mechanism through a data- brokering platform.

15. An apparatus, comprising:
at least one processor; and at least one non-transitory computer-readable medium including a computer program code; the at least one non-transitory computer-readable medium and the computer program code configured to, with the at least one processor, cause the apparatus to perform at least the following:
collecting a first set of data from user equipment associated with a plurality of users;
establishing a hierarchy between said plurality of users in relation to a predetermined data deal by using said first set of data;
aggregating a plurality of multi-dimensional and multi-source requests for a second set of data from at least a subset of said plurality of users into a singular data deal mechanism;
reducing said plurality of multi-dimensional multi-source data requests by re- allocating activated data sets shared by similar data deal mechanisms;
using data points to compare the integrity of said second set of data with a predefined threshold, wherein:
e) said predefined threshold is determined by parameters selected from the group consisting of: a geographic parameter, a demographic parameter, a behavioral parameter and combinations thereof; and
f) said hierarchy determines the final composition of said subset of said plurality of users, such that requests to lower tier users' equipment for said second sets of data is conditional to higher tiers users' acceptance.

16. The apparatus of claim 15, wherein said integrity is enhanced by investigating parameters selected form the group consisting of: name discrepancies, geo-location discrepancies, activities discrepancies, usage of aliases, simultaneous usage of the same account, simultaneous usage of multiple devices, simultaneous usage of the same device by multiple users, and combinations thereof.

17. The apparatus of claim 16, wherein said data collections have installations of quality controls selected from the group consisting of: e-wearable technology validations via proximity data tier grading to label data production based on user proximity, proximity account switching between users sharing a device, and combinations thereof.

18. The apparatus of claim 16 further configured to trigger a compensation functionality for said at least said subset of said plurality of users upon reception of said second set of data.

19. The apparatus of claim 18, wherein said compensation functionality for said at least said subset of said plurality of users is dependant form data selected from the group consisting of: rights allocation management data, usage data, rent data, lease data and combinations thereof.

20. The apparatus of claim 15, wherein said subset of said plurality of users is tested for location based aggregation.
